(19) United States
(12) Patent Application Publication
(10) Pub. No.: US 2017/0077503 A1
(43) Pub. Date: Mar. 16, 2017

(54) MULTIVALENT METAL SALTS FOR LITHIUM ION CELLS HAVING OXYGEN CONTAINING ELECTRODE ACTIVE MATERIALS

(71) Applicant: A123 Systems, LLC, Waltham, MA (US)

(72) Inventors: Michael Erickson, Plano, TX (US); Konstantin Tikhonov, Pleasanton, CA (US)

(21) Appl. No.: 15/123,626

(22) PCT Filed: Mar. 5, 2015
(86) PCT No.: PCT/US15/19025

§ 371 Date: Sep. 2, 2016

Related U.S. Application Data
(60) Provisional application No. 61/948,450, filed on Mar. 5, 2014.

(51) Int. Cl. H01M 4/36; H01M 4/505; H01M 10/0567; H01M 4/62; H01M 10/0525; H01M 4/485; H01M 4/525

(52) U.S. Cl. CPC H01M 4/366; H01M 4/485; H01M 4/505; H01M 4/525; H01M 4/62; H01M 10/0525; H01M 10/0567; H01M 2300/0025

(57) ABSTRACT

A material and method for a surface-treated electrode active material for use in a lithium ion battery is provided. The surface-treated electrode active material includes an ionically conductive layer comprising a multivalent metal present as a direct conformal layer on at least a portion of the outer surface of the electrode active material. The surface-treated electrode active material improves the capacity retention and cycle life as well as reduces undesirable reactions at the surface of the electrode active material.

### CROSS-REFERENCE TO RELATED APPLICATION

The present application claims priority to U.S. Provisional Patent Application No. 61/948,450 entitled “MULTIVALENT METAL SALTS FOR LITHIUM ION CELLS HAVING OXYGEN CONTAINING ELECTRODE ACTIVE MATERIALS,” filed Mar. 5, 2014, the entire contents of which are hereby incorporated by reference for all purposes.

### FIELD OF THE INVENTION

This application relates to materials and methods for battery electrodes, materials used therein, and electrochemical cells using such electrodes, and methods of manufacture, such as lithium secondary batteries.

### BACKGROUND AND SUMMARY

Some surface activity of electrode active materials used in positive and negative electrodes of electrochemical cells, such as lithium batteries, can have deleterious effects. For example, electrolytes may decompose on a surface of the negative electrode and/or positive electrode. This decomposition may be due to the catalytic activity of the surface of the electrode active material, electrical potential at this surface, and/or a presence of specific functional groups (e.g., hydroxyl and oxygen groups) on the surface of the electrode active material. This electrolyte decomposition and other undesirable surface reactions on the surface of the electrode active material may result in a high resistance causing capacity fade, poor rate performance, and other characteristics. Furthermore, substantial gas generation may occur inside a sealed case of a battery and cause swelling and potentially unsafe conditions. Many positive electrode active materials and negative electrode active materials can exhibit such deleterious activity. Nickel containing materials and titanium containing materials, such as lithium titanium oxide (LTO), are particularly prone to gas generation when used with many different electrolytes.

Further, the presence of metal impurities in the electrolyte may cause lithium ion cell degradation. For example, metal impurities present in the electrode active materials may leach into the electrolyte. The metal impurities, such as metal ions, may reduce on the negative electrode surface and/or co-intercalate into anode materials. For example, the dissolution of manganese into the electrolyte causes lithium ion cell degradation that utilizes negative electrode active materials, such as graphite, silicon, and others. Metal impurities are thus generally avoided in lithium ion cells. For example, electrode active materials comprising oxygen mention extremely low concentrations of metals, such as Fe, Mn, Co, Ni, Al, Na, K, Ca and Mg, in order to avoid metal impurities in a lithium ion cell.

However, the inventors herein have recognized the inclusion of a multivalent metal to treat electrode active materials to provide a surface-treated electrode active material unexpectedly improves battery performance, which is contrary to the generally accepted belief and theory. The multivalent metal may be included at a concentration amount wherein an ionically conductive layer comprising a multivalent metal forms as a direct conformal layer on the surface of the electrode active material. The multivalent metal ion may coordinate surface active groups of the electrode active material to form a surface-treated electrode active material. Coordination of the surface active groups by the multivalent metal is believed to reduce electrode active material surface reactivity and catalytic degradation mechanisms and minimize impedance growth over cell life, especially at high temperatures. The surface-treated electrode active materials showed improved capacity retention and cycle life as compared to untreated electrode active materials in Li-ion batteries. Further, the multivalent metal of the ionically conductive layer comprising a multivalent metal may interact with the surface of the electrode active material. In some examples, the multivalent metal may be present in a fully ionic, partially reduced, or fully reduced form.

It will be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF DRAWINGS

FIG. 1 is a schematic illustration of a proposed mechanism of solvent reduction on a surface of an electrode active material, for example, lithium titanate.

FIGS. 2A and 2B illustrate example schematics for forming metal ion containing layers over the surface of oxygen containing electrode active materials, in accordance with some embodiments.

FIG. 2C is a schematic illustration for forming a surface compound of metal and oxygen containing electrode active materials, in accordance with some embodiments.

FIG. 3 is an example method for treating an electrode active material, in accordance with some embodiments.

FIG. 4 is an example schematic illustration of an electrochemical cell.

FIG. 5 illustrates cycle life data at 60° C. for an electrochemical cell comprising a treated electrode, in accordance with some embodiments.

FIG. 6 illustrates calendar life capacity/retention data at 60° C. for an electrochemical cell comprising a treated electrode, in accordance with some embodiments.

FIGS. 7A and 7B are schematic top and side views of a prismatic electrochemical cell, in accordance with certain embodiments.

FIG. 7C is a schematic representation of an electrode stack in a prismatic electrochemical cell, in accordance with certain embodiments.

FIGS. 8A and 8B are schematic top and side views of a wound electrochemical cell, in accordance with certain embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” or “a mixture of” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

### INTRODUCTION

Electrolyte decomposition in an electrochemical cell often occurs on a surface of electrode active materials resulting in gas evolution and/or an increase in resistance of the cell. The gas evolution may cause swelling of the cell, rupturing of the case of the cell, and even fire and/or explosion of the cell if the gas evolution is not controlled or prevented. Furthermore, the increase in the resistance of the cell negatively impacts its rate capabilities and capacity.

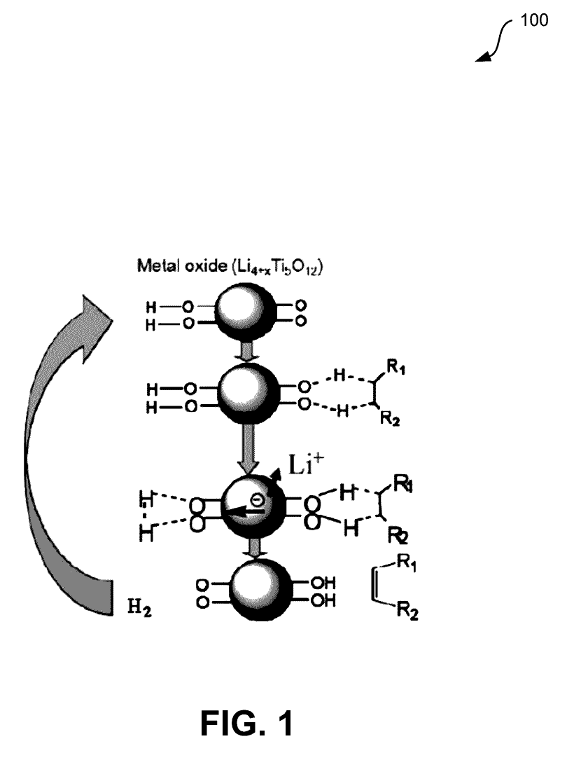

For example, a schematic illustration of a proposed mechanism of solvent reduction on the surface of an electrode active material 100 is shown in FIG. 1. The example in FIG. 1 uses lithium titanate (herein also referred to as Li₄₊ₓTi₅O₁₂ and LTO) as an example electrode active material. Without wishing to be bound by a particular theory, it is believed that metal oxides of nickel, cobalt, aluminum, titanium, and manganese can catalyze decomposition of electrolyte components and electrolyte solvents. For example, carbonates, such as ethylene carbonate (EC), dimethyl carbonate (DMC), methyl ethyl carbonate (MEC), diethyl carbonate (DEC), and solvents that are commonly used for battery electrolyte, can oxidize on the surface of many metal oxides at high potentials (e.g., greater than 4.0V, 4.5V or 5.0V). Such potentials are common for many positive electrodes. Solvents may also be reduced on the surface of the metal oxides at potentials less than about 2.0V vs Li potential. Examples of anodes based on metal oxides are anodes comprised of lithiated titanium oxide, tin oxide, niobium oxide, vanadium oxide, zirconium oxide, indium oxide, iron oxide, copper oxide and mixed metal oxides. In one example, lithium titanate, which is used for negative electrodes, includes oxide and hydroxide groups on its surface. The oxide groups are believed to be responsible for absorption of solvent molecules on the surface of lithium titanium oxide particles. The solvents may then decompose and release hydrogen and other gaseous products, thereby converting the oxide groups into hydroxide groups. At the same time, hydroxide groups of lithium titanate may undergo a reduction and release of hydrogen, as illustrated in FIG. 1, which goes into the gas phase. Other oxygen containing electrode active materials may also have oxide and hydroxide groups on their surfaces. Other electrode active materials are often imparted by surface species that introduce undesirable effects in the functioning or fabrication of the battery.

The disclosed embodiments help to overcome these problems by treating the surface of electrochemical electrode active material structures, thereby preventing or at least minimizing a direct contact between the surface of the electrode active material and various components of the electrolytes while allowing for charge carrying ions to pass. The treated surface may be formed when a multivalent metal salt contacts the electrochemically electrode active material structures and operates as a barrier between the electrode active material and the electrolyte. As a result, a less reactive surface of the electrode active material structures is exposed to the electrolyte instead of a more reactive surface of the electrode active material.

Lithium titanate (Li₄Ti₅O₁₂, often referred to as LTO) and other oxygen containing electrode active materials, such as lithium cobalt oxide (LiCoO₂, often referred to as LCO), lithium manganese oxide (LiMn₂O₄, often referred to as LMO), lithium iron phosphate (LiFePO₄, often referred to as an LFP), lithium nickel manganese cobalt oxide (LiNiMnCoO₂, often referred to as NMC), lithium nickel cobalt aluminum oxide (LiNiCoAlO₂, often referred to as NCA), lithium nickel manganese oxide (LiNiMnO₂, often referred as LNMO), silicon oxide (SiO₂), tin oxide (SnO₂), and germanium oxide (GeO₂), are commonly used for lithium ions cells because of their superior properties. For example, cells built with LTO have high rates and relative low impedance after many cycles and at extreme operating conditions, such as high temperatures. However, many of these oxygen containing electrode active materials can cause significant gas generation.

It has been found that gas generation may be reduced while capacity retention may be improved in cells containing various oxygen containing electrode active materials by treating surface of these electrode active materials with multivalent metal salts. The multivalent metal salts may be added into electrolytes as additives, used to treat electrodes containing the electrode active materials before these electrodes come in contact with electrolyte, or even used to treat particles of the electrode active materials prior or during electrode fabrication (e.g., as a slurry additive). The multivalent metal may be selected from the group consisting of: Ba, Ca, Ce, Co, Cu, La, Mg, Mn, Ni, Nb, Ag, Ti, Al, Zn, Pb, Fe, Hg, Cr, Cd, Sn, Pb, Sb, and Bi. The metal ions may be selected based on their reduction potential vs. lithium. For example, Mn²⁺ has a reduction potential of 1.855 V vs. Li. When used for passivating lithium titanate particles, Mn²⁺ may be reduced to Mn⁰ on the surface of the lithium titanate, which potential is about 1.55V, if over-potential associated with the reduction is small. Other metal ions with similar standard reduction potentials and similar (low) catalytic activity (to Mn²⁺) may also be good candidates. It was unexpectedly found that the addition of a multivalent metal ion, such as Mn²⁺ improved the performance of a Li-ion battery including a surface-treated electrode active material as disclosed.

Catalytic activity of various metals during reduction of organic species has generally not been well understood and studied. However, catalytic activity of some metals during reduction of the H⁺ ion to hydrogen gas has been thoroughly investigated and is often referred to as overvoltage of hydrogen evolution. Without being restricted to any particular theory, it is believed that the nature and the surface of the metal has an effect on the potential at which H⁺ ions are reduced into hydrogen. In simple terms, overvoltage is determined by how much the potential of the metal should be shifted from the equilibrium potential of H⁺/H₂ in given media to initiate hydrogen evolution. For example, a potential of about −1.05V vs H⁺/H₂ potential needs to be applied to a sample of lead in 1M solution of H⁺ to start generating hydrogen gas whereas one only has to apply a negative potential of few millivolts to Pt to start the same process of reducing H⁺ to gaseous hydrogen. This is because the overvoltage of hydrogen evolution on a platinum interface is low relative to other metals. As such, platinum is used as a catalyst for many organic reactions. On the other hand, the overvoltage of hydrogen evolution on a lead interface is very high. As such, lead is rarely used as a catalyst. Therefore, some correlation between the catalytic activity of the metal (reflected by its ability to catalyze electrochemical and chemical processes on its surface) and the overvoltage of hydrogen evolution derived from electrochemical measurements is believed to exist.

Based on the above perspective, the multivalent metals with high overvoltage potential should have the best ability to inhibit the reactions on the surface of the electrode active materials. For example, a multivalent metal with a hydrogen overvoltage potential of more than 0.4V may be used. Specifically, when LTO is used as an electrode active material, the metals that have the largest effect on cell performance are the ones with higher overvoltage potentials. Specifically, these metals may have an electrochemical potential higher than the LTO potential of about 1.55V versus Li. As such, these metals can be reduced or attach to the LTO surface. In some cases, when the LTO potential is driven to 1.2V, 0.7V, or 0.5V versus Li during cell formation, the metals with electrochemical potential of down to about −1.8V, −2.3V or −2.5V versus hydrogen potential can be used.

Table 1 below lists various metals electrochemical potentials and their overvoltage potentials. It is important to note that the overvoltage potentials depend on the pH of the solution, surface roughness, any surface films and the current it is measured. Metals with the potential below −1.55V versus H⁺/H₂ potential (first column) generally should not be used unless they form strong bonds with the surface, such as in the case of Al and Be. In the column listing the metals with potentials above −1.55V versus H⁺/H₂ potential, the best metals to use are the ones with the overvoltage of 0.4V and higher such as Ti, Mn, Cr, Zn, Cd, Sn, Pb, Bi, Cu, Ag and Hg.

TABLE 1

| | Standard | H* |
|---|---|---|
| M+/M | potential | [V] |
| Li/Li⁺ | −3.040 | |
| Cs/Cs⁺ | −3.026 | |
| Rb/Rb⁺ | −2.980 | |
| K/K⁺ | −2.931 | |
| Ra/Ra²⁺ | −2.912 | |
| Ba/Ba²⁺ | −2.905 | |
| Fr/Fr⁺ | −2.920 | |
| Sr/Sr²⁺ | −2.899 | |
| Ca/Ca²⁺ | −2.868 | |
| Eu/Eu²⁺ | −2.812 | |
| Na/Na⁺ | −2.710 | |
| Sm/Sm²⁺ | −2.680 | |
| Md/Md²⁺ | −2.400 | |
| La/La³⁺ | −2.379 | |
| Y/Y³⁺ | −2.372 | |
| Mg/Mg²⁺ | −2.372 | |
| Ce/Ce³⁺ | −2.336 | |
| Pr/Pr³⁺ | −2.353 | |
| Nd/Nd³⁺ | −2.323 | |
| Er/Er³⁺ | −2.331 | |
| Sm/Sm³⁺ | −2.304 | |
| Pm/Pm³⁺ | −2.300 | |
| Fm/Fm²⁺ | −2.300 | |
| Dy/Dy³⁺ | −2.295 | |
| Tb/Tb³⁺ | −2.280 | |
| Gd/Gd³⁺ | −2.279 | |
| Es/Es²⁺ | −2.230 | |
| Ac/Ac³⁺ | −2.200 | |
| Dy/Dy²⁺ | −2.200 | |
| Pm/Pm²⁺ | −2.200 | |
| Cf/Cf²⁺ | −2.120 | |
| Am/Am³⁺ | −2.048 | |
| Cm/Cm³⁺ | −2.040 | |
| Er/Er²⁺ | −2.000 | |
| Pr/Pr²⁺ | −2.000 | |
| Eu/Eu³⁺ | −1.991 | |
| Ho/Ho³⁺ | −2.330 | |
| Tm/Tm³⁺ | −2.319 | |
| Lu/Lu³⁺ | −2.280 | |
| Sc/Sc³⁺ | −2.077 | |
| Pu/Pu³⁺ | −2.031 | |
| Lr/Lr³⁺ | −1.960 | |
| Cf/Cf³⁺ | −1.940 | |
| Es/Es³⁺ | −1.910 | |
| Th/Th⁴⁺ | −1.899 | |
| Fm/Fm³⁺ | −1.890 | |
| Np/Np³⁺ | −1.856 | |
| Be/Be²⁺ | −1.847 | |
| U/U³⁺ | −1.798 | |
| Al/Al³⁺ | −1.700 | 0.7 |
| Md/Md³⁺ | −1.650 | |
| Ti/Ti²⁺ | −1.630 | |
| LTO | −1.550 | |
| Hf/Hf⁴⁺ | −1.550 | |
| Zr/Zr⁴⁺ | −1.530 | |
| Pa/Pa³⁺ | −1.340 | |
| Ti/Ti³⁺ | −1.208 | 0.5 |
| Yb/Yb³⁺ | −1.205 | |
| No/No³⁺ | −1.200 | |
| Ti/Ti⁴⁺ | −1.190 | |
| Mn/Mn²⁺ | −1.185 | 0.5 |
| V/V²⁺ | −1.175 | |
| Nb/Nb³⁺ | −1.100 | |
| Nb/Nb⁵⁺ | −0.960 | |
| V/V³⁺ | −0.870 | |
| Cr/Cr²⁺ | −0.852 | 0.5 |
| Zn/Zn²⁺ | −0.763 | 0.83 |
| Cr/Cr³⁺ | −0.740 | |
| Ga/Ga³⁺ | −0.560 | |
| Ga/Ga²⁺ | −0.450 | |
| Fe/Fe²⁺ | −0.441 | 0.36 |
| Cd/Cd²⁺ | −0.404 | 1.05 |
| In/In³⁺ | −0.338 | |
| Tl/Tl⁺ | −0.338 | |
| Co/Co²⁺ | −0.280 | 0.32 |
| In/In⁺ | −0.250 | |
| Ni/Ni²⁺ | −0.234 | 0.3 |
| Mo/Mo³⁺ | −0.200 | 0.35 |
| Sn/Sn²⁺ | −0.141 | 0.63 |
| Pb/Pb²⁺ | −0.126 | 1.05 |
| H₂/H⁺ | 0 | |
| W/W³⁺ | 0.110 | 0.26 |
| Ge/Ge⁴⁺ | 0.124 | 0.39 |
| Sb/Sb³⁺ | 0.240 | 0.67 |
| Ge/Ge²⁺ | 0.240 | |
| Re/Re³⁺ | 0.300 | |
| Bi/Bi³⁺ | 0.317 | 0.48 |
| Cu/Cu²⁺ | 0.338 | 0.48 |
| Po/Po²⁺ | 0.370 | |
| Tc/Tc²⁺ | 0.400 | |
| Ru/Ru²⁺ | 0.455 | |
| Cu/Cu⁺ | 0.522 | |
| Te/Te⁴⁺ | 0.568 | |
| Rh/Rh⁺ | 0.600 | |
| W/W⁶⁺ | 0.680 | |
| Tl/Tl³⁺ | 0.718 | |
| Rh/Rh³⁺ | 0.758 | |
| Po/Po⁴⁺ | 0.760 | |
| Hg/Hg₂²⁺ | 0.797 | 1.07 |
| Ag/Ag⁺ | 0.799 | 0.97 |
| Pb/Pb⁴⁺ | 0.800 | |
| Os/Os²⁺ | 0.850 | |
| Hg/Hg²⁺ | .851 | 4 |
| Pt/Pt²⁺ | 0.963 | 0.01 |
| Pd/Pd²⁺ | 0.980 | |
| Ir/Ir³⁺ | 1.156 | |
| Au/Au³⁺ | 1.498 | |
| Au/Au⁺ | 1.691 | |

It should be noted that metal impurities are generally avoided in lithium ion cells. For example, material specifications for LTO and other oxygen containing electrode active materials very often specifically mention extremely low concentrations of metals such as Al, Mg, Fe, Na, and others. The concern with metal impurities is that these impurities will leach into electrolyte and reduce on the surface of the negative electrode active material thereby causing battery degradation. These metals include Fe, Mn, Co, Ni, and Al. Other metals such as Na, K, Ca, and Mg are avoided because they may co-intercalate into anode materials. Specifically, multiple studies have shown that dissolution of the manganese causes lithium ion cell degradation that utilize conventional negative electrode active materials, such as graphite, silicon and silicon alloys and others. It has been unexpectedly found by the inventors, that adding some of these metals, which may generally be viewed as impurities, improves battery performance, which is contrary to the generally accepted belief and theory. In some embodiments, metal impurities have a concentration of less than 10,000 ppm or, more specifically, less than 1,000 ppm or even less than 100 ppm.

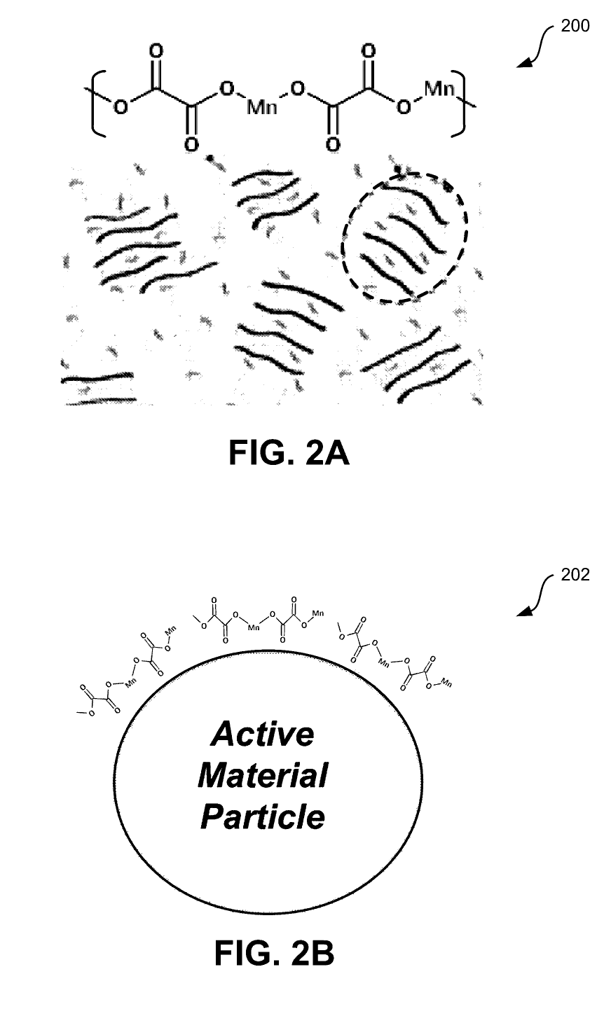

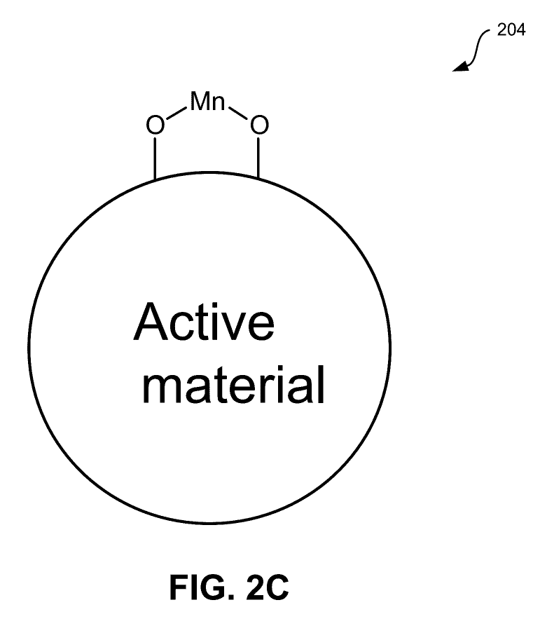

The multivalent characteristic of these metal ions help these ions to bond to the surface of oxygen containing electrode active materials. For example, the multivalent metal ions may form covalent bonds with oxygen sites available on the surface of the electrode active materials. This process may be referred to as selective coordination. Without being restricted to any particular theory, the selective coordination process will now be explained with reference to hard-soft acid-base (HSAB) theory. The HSAB theory is based on the following characteristics. Hard acids and hard bases may have small ionic radii, be highly electronegative, be weakly polarizable, and have high energy highest-occupied molecular orbitals (HOMO). On the other hand, soft acids and soft basis may have large ionic radii, be lower electronegativity, and have low energy HOMO. These characteristics and HSAB theory are used to predict stability of metal complexes. Specifically, hard Lewis acids are likely to ionically bond more strongly with hard Lewis bases than, for example, with soft Lewis bases. As such, the following metal ions corresponding to hard Lewis acids, Mg²⁺, Ca²⁺, Mn²⁺, Al³⁺ and Ti⁴⁺, will form stronger ionic bonds with hard Lewis bases, such as oxides and carboxalates. As noted above, oxygen may be present on the surface of electrode active materials (also referred to as electrode active material particles), while carboxalates represent typical electrolyte degradation products. More strongly coordinated metal ions will create better (e.g., more uniform, stronger bound, sufficient coverage) ionically conductive layer comprising a multivalent metal (herein also referred to as a multivalent metal ion layer) ionic protective films on the surfaces of electrode active material particles and prevent further electrolyte degradation. The ionically conductive layer comprising a multivalent metal may include a fully ionic, partially reduced, or fully reduced form of the multivalent metal in the layer. Furthermore, these multivalent characteristics also help with forming metal ion-containing networks (herein also referred to as a surface layer) over the surface of the oxygen containing electrode active materials, shown as surface-treated electrode active material 200 and 202 in FIGS. 2A and 2B and further described below. Multivalent metal ions may have a valence of at least about +2 and, in some embodiments, can have a valence of +3, +4, +5, and more. In one embodiment, the multivalent metal ions may have a valance of at least +2, i.e. greater than or equal to +2.

A suitable multivalent metal ion may have an atomic weight of at least 40 or even at least about 60. While smaller ions may be able to form stronger bonds with the electrode active materials and within the network, these smaller ions may interfere with lithium ion mobility within the cell and negatively impact charge and discharge rates. On the other hands, multivalent metal ions or networks (i.e. layers) formed by these ions over the oxygen containing electrode active materials need to sufficiently block other components of electrolytes, such as carbonates, which are prone to decompose when directly contacting the electrode active materials. Larger metal ions may provide better blocking characteristics because, for example, the spacing between adjacent metal ions in the network may block electrolyte components while allowing lithium ion mobility.

It should be noted that multivalent metal ions are different from charge carrying ions, such as lithium ions in lithium ion cells. The multivalent metal ions remain on the surface of electrode active material particles during operation of the cell, i.e., charge and discharge. The multivalent metal ions generally remain on the surface of the electrode active material particles in an ionic, partially reduced, or fully reduced form while carrying ions may be present throughout the entire volume of the electrode active material particles. When graphite is used as an electrode active material, the electrode potential goes close to that of 0 V versus lithium metal during charge. Any metal reduction potential over-polarization differences are often overcome resulting in reduction of the metals on the surface of graphite. An SEI layer can also form on these metal particles further increasing anode impedance. Furthermore, reduced metal may form dendrite that can cause internal shorts. For example, iron is known to be reduced on the surface of graphite, and, if sufficient iron is present, iron dendrites can form and short the cell. In another example, when lithium titanate is used as negative electrode active material, the operating potential of the lithium titanate is significantly higher than that of graphite. As such, when iron ions are used as a part of multivalent metal salts, these iron ions may not reduce on the surface of the lithium titanate particles and may remain in a surface layer that protects the lithium titanate particles from directly contacting various electrolyte components, such as carbonates.

Multivalent metal ions may form salts with various negative ions, such as imide ions, hexafluorophosphate (PF₆⁻) ions, tetrafluoroborate (BF₄⁻) ions, and chlorate ions (ClO₄⁻) ions. Some examples of imide ions include bis(fluorosulfuryl) imide (N(SO₂F)₂⁻) ions, bis(trifluoromethanesulfonyl) imide (N(SO₂CF₃)₂⁻) ions, bis (perfluoroethylsulfonyl) imide (N(SO₂C₂F₅)₂⁻) ions. Additional examples include C(SO₂CF₃)₃⁻ ions, PF₄(CF₃)₂⁻ ions, PF₃(C₂F₅)₃⁻ ions, PF₃(CF₃)₃⁻ ions, PF₃(iso-C₃F₇)₃⁻ ions, and PF₅(iso-C₃F₇)⁻ ions. More generally, multivalent metal ions may be fluoroalkyl-substituted PF₆⁻ ions having a general structure PFₓR₁₋ₓ⁻, wherein x is from 1 to 5 and wherein at least one R (if present) is a fluorinated alkyl having a chain length of from 1 to 8. Multivalent metal ions may be fluoroalkyl-substituted BF₄⁻ ions having a general structure BFₓR₁₋ₓ⁻, wherein x is from 1 to 4 and wherein at least one R (if present) is an fluorinated alkyl having a chain length of from 1 to 8. Multivalent metal ions may be linear imide ions having a general structure N(—SO₂—R)₂⁻, wherein at least one R is a fluorinated alkyl having a chain length of from 1 to 8. Multivalent metal ions may be cyclic imide ions having a general structure N(—SO₂—R—)⁻, wherein R is fluorinated alkyl having a chain length of from 1 to 8. Finally, multivalent metal ions may be methide salts having a general structure C(—SO₂—R)₃⁻, wherein at least one R is fluorinated alkyl with a chain length of from 0 to 8. Additional examples include BOB- (bisoxalatoborate) and DFOB- (difluorooxalatoborate). Without being restricted to any particular theory, it is believed that imides ions may provide stable and low resistance SEI layers on positive electrodes. As such, imides ions may be used for various multivalent metal salts used for passivating positive oxygen containing electrode active materials. In addition, when added in amounts less than 0.2M or 0.1M or preferably in less than 0.01M concentration, the multivalent metals can be added in the form of nitrate, nitrite and other salts. In cases when concentration is sufficiently low, anions that are generally considered detrimental to Li-ion batteries can be used. Examples include chloride, sulfate, acetates, which are typically not used in Li-ion battery electrolytes due to their reactivity towards anode and cathode materials as well as corrosion of a current collector they may cause. It was unexpectedly found that in small concentrations the multivalent metal may be used because the positive effect of adding the multivalent metal overweighs any possible negative impact of introduction of these anions.

Specific examples of multivalent metal salts include manganese bis(trifluoromethanesulfonyl) imide (Mn(N(SO₂CF₃)₂)₂), magnesium bis(trifluoromethanesulfonyl) imide (Mg(N(SO₂CF₃)₂)₂), calcium bis(trifluoromethanesulfonyl) imide (Ca(N(SO₂CF₃)₂)₂), cobalt bis(trifluoromethanesulfonyl)imide (Co(N(SO₂CF₃)₂)₂), nickel bis(trifluoromethanesulfonyl) imide (Ni(N(SO₂CF₃)₂)₂), copper bis(trifluoromethanesulfonyl) imide (Cu(N(SO₂CF₃)₂)₂), zinc bis(trifluoromethanesulfonyl) imide (Zn(N(SO₂CF₃)₂)₂), cesium bis(trifluoromethanesulfonyl)imide (Cs(N(SO₂CF₃)₂)₂), barium bis(trifluoromethanesulfonyl) imide (Ba(N(SO₂CF₃)₂)₂), lanthanum bis(trifluoromethanesulfonyl)imide (La(N(SO₂CF₃)₂)₂), and cerium bis(trifluoromethanesulfonyl)imide (Ce(N(SO₂CF₃)₂)₂). Many of these salts are commercially available for other applications.

Without being restricted to any particular theory, it is believed that these multivalent metal salts form structured and ionically conductive films on the surface of electrode active material particles during charge/discharge cycling. The multivalent metal ion may form as a direct conformal layer on the electrode active material. The ion in the multivalent metal may be present in the ionically conductive layer comprising a multivalent metal (herein also described as multivalent metal ion layers) as fully ionic, partially reduced, or fully reduced. In some embodiments, multivalent metal ions from these salts can preferentially form ionically conductive multilayer metal layers, for example, ionic surface film networks, including of metal-divalent anion (e.g., oxygen ion) link. These ionic lattices form conformal coatings on the surface of electrode active material particles through coordination mechanisms as, for example, shown in FIGS. 2A and 2B. The multivalent metal ions may also coordinate surface active groups, shown as surface-treated electrode active material 204 in FIG. 2C. Both types of coordination are believed to reduce electrode active material surface reactivity and catalytic degradation mechanisms and minimize impedance growth over cell life, especially at high temperatures. Thus, a surface-treated electrode active material may be provided comprising an electrode active material having an outer surface and an ionically conductive layer comprising a multivalent metal wherein the layer is a direct conformal layer on the outer surface of the electrode active material. For example, the surface-treated electrode active material may be provided comprising an oxygen containing electrode active material having an outer surface and a multivalent metal ion layer. The multivalent metal ion layer is a direct conformal layer on the outer surface of the oxygen containing electrode active material, for example as illustrated in FIGS. 2A, 2B, and 2C. The direct conformal layer is an ionically conductive layer. The ionically conductive layer comprising a multivalent metal may include metal ions which are present in their fully ionic form, partially reduced form, or fully reduce form. The electrode active material for the surface-treated electrode active material may be an anode material comprising a lithiated metal oxide, the metal oxide selected from one of: titanium oxide, tin oxide, niobium oxide, vanadium oxide, zirconium oxide, indium oxide, iron oxide, copper oxide or mixed metal oxides. For example, the negative electrode active material may be an oxygen containing electrode active materials comprising one of lithium titanate (Li₄Ti₅O₁₂), lithium cobalt oxide (LiCoO₂), lithium manganese oxide (LiMn₂O₄), lithium iron phosphate (LiFePO₄), lithium nickel manganese cobalt oxide (LiNiMnCoO₂), or lithium nickel cobalt aluminum oxide (LiNiCoAlO₂). In some examples, the oxygen containing electrode active material may comprise lithium titanate. The electrode active material for the surface-treated electrode active material may be a cathode comprising a positive electrode active material comprising a lithiated metal oxide, the metal oxide selected from one of vanadium oxide, manganese oxide, iron oxide, cobalt oxide, nickel oxide, aluminum oxide, silicon oxide or a combination thereof; a lithium metal silicide; a lithium metal sulfide; a lithium metal phosphate; or a lithium mixed metal phosphate.

The ionically conductive layer comprising a multivalent metal may comprise a multivalent metal having a hydrogen overvoltage potential of more than 0.4V. The ionically conductive multivalent metal may be selected based on the multivalent metal electrochemical potential being higher than a potential of the electrode active material versus lithium. For example, the multivalent metal of the ionically conductive layer may be selected from a group consisting of: Ba, Ca, Ce, Co, Cu, La, Mg, Mn, Ni, Nb, Ag, Ti, Al, Zn, Pb, Fe, Hg, Cr, Cd, Sn, Pb, Sb, and Bi. The multivalent metal may be provided by a multivalent metal salts comprising an ion of the multivalent metal and a negative ion selected from one of: hexafluorophosphate ion; tetrafluoroborate ion; chlorate ion; C(SO₂CF₃)₃⁻ ion; PF₄(CF₃)₂⁻ ion; PF₃(C₂F₅)₃⁻ ion; PF₃(CF₃)₃⁻ ion; PF₃(iso-C₃F₇)₃⁻ ion; PF₅(iso-C₃F₇)⁻ ion; imide ion wherein the imide ion is selected from one of bis(fluorosulfuryl) imide ion, bis(trifluoromethanesulfonyl) imide ion, bis(perfluoroethylsulfonyl) imide ion, linear imide ions having a general structure N(—SO₂—R)₂⁻, wherein at least one R is a fluorinated alkyl having a chain length of from 1 to 8, cyclic imide ions having a general structure N(—SO₂—R—)⁻, wherein R is fluorinated alkyl having a chain length of from 1 to 8; methide ion having a general structure C(—SO₂—R)₃⁻, wherein R is a fluorinated alkyl with a chain length of from 0 to 8; bisoxalatoborate; or difluorooxalatoborate.

It should be noted that multivalent metal salts may not work well with some other electrode active materials, such as graphite. For example, incorporating of metal ions into a solid electrolyte interface (SEI) layer tend to increase electronic conductivity of this layer.

In some embodiments, the ionically conductive layer comprising a multivalent metal may comprise the multivalent metal is in at least a partially reduced form on the outer surface of the electrode active material.

Multivalent metal salts may be dissolved in a liquid to form a solution that comes in contact with electrode active materials, such as slurry or electrolyte. In specific embodiments, a multivalent metal salt is dissolved in an electrolyte containing one or more carbonate solvents. The electrolyte also includes one or more lithium containing salts, such as LiPF₆, LiBF₄, LiClO₄ LiAsF₆, LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), lithium salts having cyclic alkyl groups (e.g., (CF₂)₂(SO₂)₂ₓLi and (CF₂)₃(SO₂)₂ₓLi), and combinations thereof. Common combinations include LiPF₆ and LiBF₄, LiPF₆ and LiN(CF₃SO₂)₂, LiBF₄ and LiN(CF₃SO₂)₂. Various examples of electrolyte solvents and salts are described below.

In some embodiments, an electrolyte includes 0.2M of LiN(CF₃SO₂)₂ and 0.8M of LiPF₆ dissolved in a mixture of propylene carbonate and ethyl-methyl carbonate. This combination of lithium containing salts and solvents may be referred to as a base electrolyte. Various multivalent metal ion additives may be added to this base electrolyte to improve performance of a cell. One example of an electrolyte additive may be manganese bis(trifluoromethanesulfonyl)imide (Mn(N(SO₂CF₃)₂)₂). The amount of this additive in the base electrolyte may be between about 0.01M and 1M or, more specifically, between about 0.02M and 0.5M, such as about 0.1M. These amounts of additives may be used for manganese bis(trifluoromethanesulfonyl)imide added into other base electrolytes. Likewise, these amounts may be used for other multivalent metal ion additives that are added to base electrolytes, such as the base electrolyte specified above or some other base electrolyte. The amount may depend on the types of additives (e.g., multivalent metal salts having smaller molecules may be added at larger amounts), the type of oxygen containing electrode active materials (e.g., the particles with larger surface areas may need more additives), the type of solvents (e.g., solvents may impose solubility limits on various additives), and other factors.

For example, a non-aqueous electrolyte, comprising at least one non-aqueous solvent and one or more lithium containing salts, selected from LiPF₆, LiBF₄, LiClO₄ LiAsF₆, LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), lithium salts having cyclic alkyl groups and combinations thereof may be provided.

In some embodiments, the non-aqueous electrolyte may further comprise a multivalent metal salt having a concentration between about 0.01M and 0.2M wherein the multivalent metal salt comprises a multivalent metal ion having a valance of at least +2. In other embodiments, the concentration of the multivalent metal salt may be between about 0.05M to 0.10M. In one example, the multivalent metal salt the multivalent metal salt is at least one of: an imide salt selected from one of: manganese bis(trifluoromethanesulfonyl) imide (Mn(N(SO₂CF₃)₂)₂), magnesium bis(trifluoromethanesulfonyl) imide (Mg(N(SO₂CF₃)₂)₂), calcium bis(trifluoromethanesulfonyl) imide (Ca(N(SO₂CF₃)₂)₂), cobalt bis(trifluoromethanesulfonyl)imide (Co(N(SO₂CF₃)₂)₂), nickel bis(trifluoromethanesulfonyl) imide (Ni(N(SO₂CF₃)₂)₂), copper bis(trifluoromethanesulfonyl) imide (Cu(N(SO₂CF₃)₂)₂), zinc bis(trifluoromethanesulfonyl) imide (Zn(N(SO₂CF₃)₂)₂), cesium bis(trifluoromethanesulfonyl)imide (Cs(N(SO₂CF₃)₂)₂), barium bis(trifluoromethanesulfonyl) imide (Ba(N(SO₂CF₃)₂)₂), lanthanum bis(trifluoromethanesulfonyl)imide (La(N(SO₂CF₃)₂)₂), and cerium bis(trifluoromethanesulfonyl)imide (Ce(N(SO₂CF₃)₂)₂); or comprises a multivalent metal ion selected from one of: Ba, Ca, Ce, Co, Cu, La, Mg, Mn, Ni, Nb, Ag, Ti, Al, Zn, Pb, Fe, Hg, Cr, Cd, Sn, Pb, Sb, Bi, paired with a negative ion selected from one of: hexafluorophosphate ion; tetrafluoroborate ion; chlorate ion; C(SO₂CF₃)₃⁻ ion; PF₄(CF₃)₂⁻ ion; PF₃(C₂F₅)₃⁻ ion; PF₃(CF₃)₃⁻ ion; PF₃(iso-C₃F₇)₃⁻ ion; PF₅(iso-C₃F₇)⁻ ion; imide ion wherein the imide ion is selected from one of bis(fluorosulfuryl) imide ion, bis(trifluoromethanesulfonyl) imide ion, bis(perfluoroethylsulfonyl) imide ion, linear imide ions having a general structure N(—SO₂—R)₂⁻, wherein at least one R is a fluorinated alkyl having a chain length of from 1 to 8, cyclic imide ions having a general structure N(—SO₂—R—)⁻, wherein R is fluorinated alkyl having a chain length of from 1 to 8; methide ion having a general structure C(—SO₂—R)₃⁻, wherein R is a fluorinated alkyl with a chain length of from 0 to 8; bisoxalatoborate; or difluorooxalatoborate. In another example, wherein the multivalent metal salt comprises a multivalent metal ion and a negative ion wherein the multivalent metal ion is selected from the group consisting of Ba, Ca, Ce, Co, Cu, La, Mg, Mn, Ni, Nb, Ag, Ti, Al, Zn, Pb, Fe, Hg, Cr, Cd, Sn, Pb, Sb, and Bi; and wherein the negative ion is selected from the group consisting of hexafluorophosphate ion; tetrafluoroborate ion; chlorate ion; C(SO₂CF₃)₃⁻ ion; PF₄(CF₃)₂⁻ ion; PF₃(C₂F₅)₃⁻ ion; PF₃(CF₃)₃⁻ ion; PF₃(iso-C₃F₇)₃⁻ ion; PF₅(iso-C₃F₇)⁻ ion; imide ion wherein the imide ion is selected from one of bis(fluorosulfuryl) imide ion, bis(trifluoromethanesulfonyl) imide ion, bis(perfluoroethylsulfonyl) imide ion, linear imide ions having a general structure N(—SO₂—R)₂⁻, wherein at least one R is a fluorinated alkyl having a chain length of from 1 to 8, cyclic imide ions having a general structure N(—SO₂—R—)⁻, wherein R is fluorinated alkyl having a chain length of from 1 to 8; methide ion having a general structure C(—SO₂—R)₃⁻, wherein R is a fluorinated alkyl with a chain length of from 0 to 8; bisoxalatoborate; and difluorooxalatoborate.

### Processing Examples

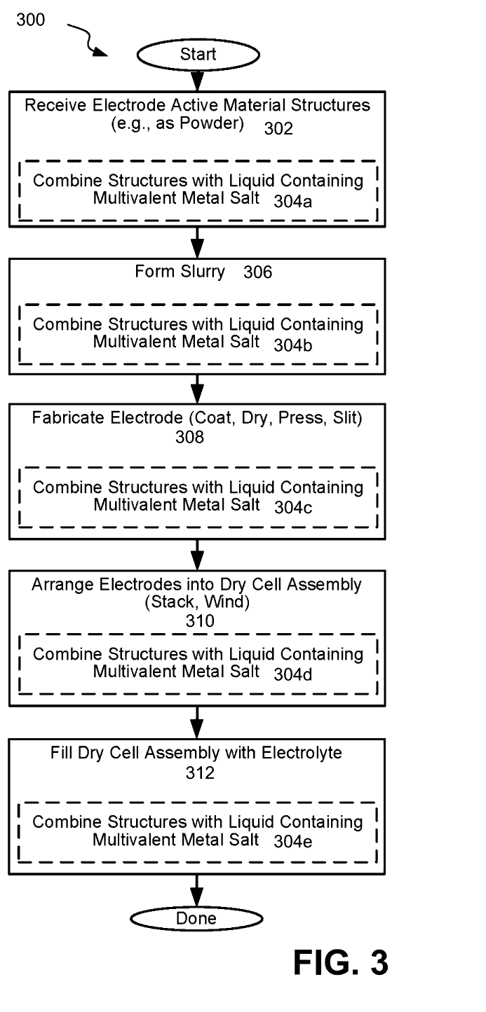

Treating a surface of oxygen containing electrode active materials with multivalent metal salts may be performed at different stages of fabricating electrode active materials or using electrode active materials for fabricating electrodes and cells as described below with reference to FIG. 3. The stage at which the surface treatment is performed may be selected based on the type of the electrode active materials (e.g., its composition, morphology, shape of structures, and size of structures), processing conditions, and other factors. It should be noted that using the same multivalent metal salt at different stages may produce different kinds of surface treatment. For example, the ionically conductive multivalent metal surface layers may comprise the multivalent metals. The form of the multivalent metals in the ionically conductive multivalent metal surface layer will depend on the electrode active material. The multivalent metal may be present in metallic form (i.e. fully reduced from the ionic form), in the form of a salt (i.e. ionic form), or as structures formed with the active groups present on the electrode active material (i.e. a coordinate bond). The ionically conductive multivalent metal surface layer may form a direct conformal layer on the surface of the electrode active material.

FIG. 3 is a process flowchart corresponding to method 300 including treatment of oxygen containing electrode active material structures, in accordance with some embodiments. The treatment may include contacting the solution comprising the multivalent metal ion with the electrode active material as shown by operations 304a, 304b, 304c, 304d, and 304e. Different liquids may be used and different mixtures may be formed depending on when this treatment is performed in the overall method 300. For example, a multivalent metal salt may be added into electrolyte is treatment is performed during operation 304e.

In some embodiments, only one of these treatment operations 304a, 304b, 304c, 304d, and 304e is performed. Alternatively, two or more of treatment operations 304a, 304b, 304c, 304d, and 304e may be performed. When multiple treatment operations are used, the initial operation may form a partial surface layer on the oxygen containing electrode active material structures that is later modified or added to during one or more subsequent treatment operations. For example, the surface of the active material may be first treated with molybdenum compounds and manganese compounds can be added to electrolyte.

Some of operations 304a, 304b, 304c, 304d, and 304e may be parts of other operations used to fabricate electrodes and/or cell assemblies. Alternatively, some of these operations may be standalone operations. For example, treatment during operation 304a may be performed on electrode active materials received in a powder form (and before these structures are combined with a polymer binder to form slurry). A multivalent metal salt may be a part of the liquid specially designed to treat the powder and, in some embodiments, to yield a powder after processing. In addition to the multivalent metal salt, this liquid may include other components, such as one or more solvents. The mixture formed when the liquid is combined with the electrode active materials is then processed to recover electrode active materials with a treated surface. As such, operation 304a may be a standalone operation and not integrated into another operations used to fabricate electrodes or cell assemblies. Alternatively, operation 304a may be implemented as a part of electrode active material fabrication (e.g., during final stages of processing).

Surface treatment during operation 304c may be performed on a partially assembled electrode (e.g., a coated current collector) or a fully assembled electrode (e.g., a pressed and slit electrode) before the electrode is arranged into a stack or a jelly roll with one or more other electrodes. Operation 304c may also be a standalone operation that is performed during or after electrode fabrication. A multivalent metal salt may be a part of the liquid specially designed to treat electrodes.

Surface treatment during operation 304d may be performed on a stack or a jelly roll, which may be collectively referred to as a dry cell assembly, prior to introducing an electrolyte into this assembly. Again, operation 304d may be a standalone operation. A multivalent metal salt may be a part of the liquid specially designed to treat dry cell assemblies. For example, the liquid may include one or more solvents that easily evaporate without a need for excessive temperatures, e.g., below the temperature threshold of the separator used for the dry cell assembly. The liquid may be removed from the dry cell assembly at the end of operation 304d.

On the other hand, operation 304b and/or operation 304e may be performed as parts of standard fabrication operations. For example, operation 304b may be a part of slurry mixing and electrode coating. During this operation, the electrode active materials may be in slurry. This slurry is later used to coat a current collecting substrate. A multivalent metal salt may be added into the slurry after or before the electrode active materials are added into the slurry.

In another example presented by operation 304e, electrode active materials are received as a part of a dry cell assembly or, more specifically, as one or more electrodes arranged with one or more other electrodes into the dry cell assembly. A multivalent metal salt may be added as a part of electrolyte used to fill the cell. As such, the electrode active materials are combined with a liquid containing a multivalent metal salt when the electrolyte soaks the one or more electrodes containing the structures.

Overall, electrode active materials may be provided as a powder during operations 302 and/or 306, as a part of an electrode (full or partially fabricated) during operation 308, and as a part of a dry cell assembly ready to be filled with an electrolyte during operations 310 and 312. In some embodiments, surface treatment may be formed before these electrode active material structures are combined with other electrode materials to form slurry or, more specifically, before these structures are combined with a polymer binder. This example is illustrated by a combination of operations 302 and 304a in FIG. 3. At this stage of the processing, electrode active materials received during operation 302 may be referred to as a raw material. In some embodiments, the received structures may be pre-mixed with one or more conductive additives, such as graphite, acetylene black, carbon nanotubes, ceramics, other electrode active materials, and the like, prior to surface treatment. Pre-mixing may be used, for example, for coating of electrode active material structures with carbon additives.

During operation 304a, the electrode active materials provided during operation 302 are combined with a liquid including a multivalent metal salt. Alternatively, the multivalent metal salt may be added into a mixture containing the electrode active materials and the electrode active materials, e.g., after the liquid is combined with the electrode active materials. The amount of the multivalent metal salt may depend on the size and shape of electrode active materials or, more specifically, on the surface area of these structures that needs to be treated. For example, smaller particles may require more multivalent metal salt, while larger particles may need less. The ranges provided herein are generally applicable for electrode active materials having an average size of between about 2 micron and about 50 microns. These particles can be macrostructures made of smaller particles, sometimes called crystalline, having an average size of between about 0.04 micron to 0.4 micron. Other factors impacting the amount of the multivalent metal salt needed for treatment are listed above.

In some embodiments, the amount of multivalent metal salt in the mixture is between about 0.2% by weight and about 20% by weight relative to the weight of the electrode active materials. In one example, the amount of the multivalent metal salt may be between 0.2% by weight to 5% by weight, or 0.2% by weight to 2% by weight relative to a weight of the electrode active material. In yet another example, the amount of the multivalent metal salt may be between about 0.25% by weight and about 5% by weight or even between about 0.5% by weight and about 2% by weight. These amounts are believed to create a conformal monolayer on the surface of the structures and to avoid excess multivalent metal salt in the mixture that has not reacted or otherwise attached to the surface of the structures. Various examples of multivalent metal salts are presented below. The ranges of the multivalent metal salt described above are also applicable to multivalent metal salts used in operations 304b, 304c, 304d, and 304e as further described below.

The electrode active materials may be combined with the liquid by mixing these two components and forming a mixture or, more specifically, a suspension during operation 304a. This mixture should be distinguished from slurry that may be provided, for example, during operation 306. This mixture includes a multivalent metal salt, which may be provided as a part of the liquid or added into the mixture after the electrode active materials are combined with the liquid. The electrode active materials may be actively suspended in the liquid by continuous mixing, thereby ensuring adequate contact between the structures and the multivalent metal salt. In some embodiments, the mixture can be heated to improve reaction kinetics but without shifting the thermodynamic reaction equilibrium. The electrode active materials may then be filtered and washed one or more times (e.g., twice) with a solvent used in the liquid (e.g., ethanol). The filtered structures may then be dried to remove remaining components of the liquid. For example, the electrode active materials may be dried at a temperature of between about 80° C. and about 240° C. for between about 4 hours and 72 hours or, more specifically, at a temperature of about 210° C. for about 24 hours. Overall, after surface treating the electrode active materials, the structures may be separated from the liquid and formed into, for example, a powder before using these structures for electrode fabrication. The dried electrode active materials may be ready for use in later operations, such as operation 306. Operation 304a may be performed by a raw material supplier, by an electrode manufacturer, or by a battery manufacturer.

In some embodiments, operation 304a is not performed and method 300 proceeds from operation 302 directly to operation 306. On the other hand, if operation 304a is performed, it may be the only surface treatment operation in the entire method 300 or combined with one or more other surface treatment operations 304b, 304c, 304d, and 304e.

Method 300 may then proceed with operation 306, during which electrode active materials are combined with other electrode materials to form slurry. During this operation, the structures are at least combined with at least a polymer binder. However, other materials, such as conductive additives and/or solvents, may be added to the mixture to form the slurry. Slurry formulation depends on desired performance characteristics of the battery (e.g., rate capability, capacity), electrode active material (e.g., composition, size of structures), and other factors. Slurry formulation would be understood by one having ordinary skills in the art. The multivalent metal salt may be added into the fully formulated slurry (i.e., all other components of the slurry present) or partially formulated slurry (e.g., some components other than electrode active materials structures are missing). For example, in the latter case, the remaining solvent and/or binder may be added after adding the multivalent metal salt. In the partially formulated slurry, the same amount of the multivalent metal salt will have a high concentration than in the fully formulated slurry. The high concentration may be desirable from the kinetics and/or thermodynamics perspective. In the latter case, most of the treatment may be performed before adding the remaining components into the slurry.

Operation 304b may be a part of operation 306. In this example, the mixture that contains a multivalent metal salt is the slurry. It should be noted that the multivalent metal salt may be added (e.g., into the liquid or another component) prior to forming the slurry or after the slurry is formed. In either case, the multivalent metal salt eventually comes in contact with the structures and treats the surface of the electrode active material. In some embodiments, the surface treatment may start as soon as the slurry is formed (e.g., components of the slurry are mixed together). The slurry may be outgassed to remove reaction products (e.g., gases generated during surface treatment). Furthermore, the slurry may be heated for a period of time (prior to coating the slurry on a current collecting substrate) to speed up the treatment process.

In some embodiments, operation 304b is not performed. On the other hand, if operation 304b is performed, it may be the only surface treatment operation in the entire method 300 or combined with one or more other surface treatment operations 304a, 304c, 304d, and 304e.

Method 300 may then proceed with fabricating an electrode during operation 308. This operation involves a series of steps, such as coating slurry onto a current collecting substrate, drying the slurry to form an initial electrode active material layer, compressing the layer to achieve a desirable density, slitting the electrode to its final width and length. The current collecting substrate may receive one or two electrode active material layers during operation. These layers are initially formed when the current collecting substrate is coated with the slurry and dried. The layers may be then pressed to the right density. In some embodiments, electrode active materials are treated while they are part of an electrode active material layer.

For purposes of this document, an electrode assembly is referred to as a structure at any stage of operation 308. As such, the electrode assembly covers both fully fabricated electrodes and partially fabricated electrodes. For example, operation 304c may be performed on the electrode assembly prior to its compressing, after compressing but prior to slitting, or after slitting. A liquid containing the multivalent metal salt may be dispensed over each electrode active material layer of the electrode assembly. In some embodiments, the electrode assembly is dipped (partially or completely) into a liquid containing a multivalent metal salt. The liquid is allowed to soak into electrode active material layers to ensure contact between the multivalent metal salt and the electrode active materials. The liquid may be heated to between about 50° C. and 200° C. Overall, a presence of polymer binders, such as polyvinylidene fluoride, carboxymethyl cellulose (or a salt of carboxymethyl cellulose), and styrene butadiene rubber, in the electrode may limit the processing temperature to less than 200° C., or sometimes less than 170° C. and even less than 130° C. because higher temperatures may melt or degrade the binder material.

Furthermore, a temporary electrochemical cell may be formed during operation 304c to conduct the surface treatment of an electrode assembly. The electrode assembly may be submerged into a liquid that contains charge carrying ions. In some embodiments, charge carrying ions may be formed by a multivalent metal salt. For example, the charge carrying ions may be multivalent metal ions of the salt. A voltage may be applied to the current collecting substrate of the electrode assembly to ensure the flow of the ions in the temporary cell.

In some embodiments, operation 304c is not performed. On the other hand, if operation 304c is performed, it may be the only surface treatment operation in the entire method 300 or combined with one or more other surface treatment operations 304a, 304b, 304d, and 304e.

Method 300 may then proceed with arranging electrodes into a dry cell assembly, such as a stack or a jellyroll, during operation 310. This operation may involve winding two electrodes together with separator sheets or stacking electrodes with separator sheets. Operation 310 will be understood by one having ordinary skills in the art.

At least one of these arranged electrodes includes electrode active materials that have treated surface or that is treated in later operations. In some embodiments, surface treatment may be performed on electrode active materials after two or more electrodes are arranged into the dry cell assembly, for example, in operation 304d (i.e., prior to introducing an electrolyte into the dry cell assembly). During operation 304d, a liquid containing a multivalent metal salt may be introduced in a way similar to filling an electrolyte. However, the liquid may be at least partially removed. In some embodiments, after the surface treatment, most of the liquid is removed from the dry cell assembly. For example, a multivalent metal salt may be dissolved in a solvent that is later evaporated leaving the multivalent metal salt on the surface of the cell components. In some embodiments, any unreacted multivalent metal salt may be also removed from the dry cell assembly by, for example, evaporation or subsequent washing of the assembly with a solvent and drying the assembly. Similar to the electrode treatment, treatment of the arranged electrodes may involve electrochemical reactions. The treatment temperature during operation 304d is limited by the separator and/or other temperature sensitive components that may be presented in the assembly. In some embodiments, the temperature used in operation 304d is between about 30° C. and about 200° C. or, more specifically, between about 40° C. and about 80° C. Higher temperatures may cause separator degradation. In some embodiments, temperatures as high as 210° C. and even as high as 280° C. may be used. In one example embodiment, 200° C. may be used with some separator materials. For example, high temperature separators including cellulose, polyethylene terephthalate, or aramid may be used, thereby allowing higher temperatures. The same temperature considerations are applicable to operation 304e further described below.

In some embodiments, operation 304d is not performed. On the other hand, if operation 304d is performed, it may be the only surface treatment operation in the entire method 300 or combined with one or more other surface treatment operations 304a, 304b, 304c, and 304e.

Method 300 may then proceed with filling the dry cell assembly with electrolyte during operation 312. The dry cell assembly may include a pouch or a case for containing the electrolyte. In some embodiments, operation 312 may include outgassing. Operation 312 may include operation 304e, such that the surface treatment is performed on the electrode active materials when one or more electrodes containing these structures and arranged into the dry cell assembly come in contact with the electrolyte. A multivalent metal salt may be a part of the electrolyte. In other words, surface treatment is carried out when the cell is filled with the electrolyte containing the multivalent metal salt. The surface treatment may continue during initial formation cycling and even during later operational cycling. For example, the solution comprising the multivalent metal salt is an electrolyte of a lithium ion cell. The electrolyte may further comprise a lithium containing salt. In one example, the lithium containing salt may comprise one of LiPF₆, LiBF₄, LiClO₄ LiAsF₆, LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, or LiPF₅(iso-C₃F₇). In another example, the solution comprising the multivalent metal salt is an electrolyte of a lithium ion cell, the electrolyte further comprising a lithium containing salt, wherein the lithium containing salt is selected from the group consisting of LiPF₆, LiBF₄, LiClO₄ LiAsF₆, LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, and LiPF₅(iso-C₃F₇). Thus, the surface-treated electrode active material may be prepared using a solution comprising the multivalent metal salt which also acts as the electrolyte for the electrochemical cell. The concentration of the multivalent metal salt in the solution may be between 0.01M and 0.2M. In other examples, the concentration of the multivalent metal salt may be less than 0.2M or 0.1M or less than 0.01M concentration. Further, addition of the multivalent metal salt to the electrolyte to form the solution eliminates additional processing steps.

In some embodiments, operation 304e is not performed and surface treatment is performed on electrode active materials during one or more of operations 304a, 304b, 304c, and 304d. On the other hand, if operation 304e is performed, it may be the only surface treatment operation in the entire method 300 or combined with one or more other surface treatment operations 304a, 304b, 304c, and 304d.

Thus, method 300 is provided for preparing a surface-treated electrode active material. The method may comprise receiving an oxygen containing electrode active material; preparing a solution comprising a multivalent metal salt; and contacting the prepared solution with the oxygen containing electrode active material, forming a surface layer comprising multivalent metal ions of the multivalent metal salt. The surface layer is disposed on a surface of the oxygen containing electrode active material. The surface-treated electrode active materials may be prepared using method 300 as disclosed. In another embodiment, the method may comprise receiving an electrode active material, preparing a solution comprising a multivalent metal salt, contacting the prepared solution with the oxygen containing electrode active material, and forming a surface layer comprising multivalent metal ions of the multivalent metal salt, the surface network disposed on a surface of the oxygen containing electrode active material.

In some embodiments, the electrode active material may be an anode comprising a lithiated metal oxide, the metal oxide selected from one of: titanium oxide, tin oxide, niobium oxide, vanadium oxide, zirconium oxide, indium oxide, iron oxide, copper oxide or mixed metal oxides. In another embodiment, the electrode active material is an anode comprising a lithiated metal oxide wherein the metal is selected from the group consisting of titanium, tin, niobium, vanadium, zirconium, indium, iron, and copper.

In other embodiments, the electrode active material is a cathode comprising a lithiated metal oxide, the metal oxide selected from one of vanadium oxide, manganese oxide, iron oxide, cobalt oxide, nickel oxide, aluminum oxide, silicon oxide or a combination thereof; a lithium metal silicide; a lithium metal sulfide; a lithium metal phosphate; or a lithium mixed metal phosphate. In yet other embodiments, the electrode active material is a cathode comprising a lithiated metal oxide, wherein the metal oxide is selected from a group consisting of vanadium oxide, manganese oxide, iron oxide, cobalt oxide, nickel oxide, aluminum oxide, silicon oxide or a combination thereof; a lithium metal silicide; a lithium metal sulfide; a lithium metal phosphate; a lithium mixed metal phosphate; lithium insertion compounds with olivine structure such as LixMXO₄, where M is a transition metal selected from Fe, Mn, Co, Ni, and a combination thereof, X is selected from P, V, S, Si and combinations thereof, and the value of x is between about 0 and 2.

The duration of the treatment depends on the reactivity of the material surface towards the multivalent metal salt. In some embodiments, the contact time between the electrode active materials and the multivalent metal salt is no longer than about 72 hours or, more specifically, no longer than about 24 hours, no longer than 2 hours, or even no longer than about 30 minutes.

Regardless of the stage of the surface treatment, combining the electrode active materials with a liquid may be performed within a short duration after drying the structures, e.g., exposing the structures to above 200° C. under a vacuum to reduce absorbed moisture. In some embodiments, that duration (i.e., between drying and surface treating) may be less than about 24 hours, less than about 4 hours, or even less than about 2 hour to prevent post-drying adsorption of moisture and, in some embodiments, formation of lithium carbonates on the surface of the electrode active materials. In addition or instead of this limited duration, contact with air or, more specifically, with moisture in the air may be prevented by using dry gases, moisture barrier packaging, and other such techniques.

Additionally, other types of processing may be used in conjunction with combining the electrode active materials with the liquid in order to facilitate the reaction or provide an additional reaction/transformation. Such processing may be conducted either at the same time as, prior to, or after the reaction of the reactive solution to the electrode active material suspension. Examples of such other processing may include high-temperature treatments, irradiation with x-rays or other forms of electromagnetic radiation, ultrasonic agitation, other forms of mechanical stimulation, and so forth. For example, when electrode active materials are treated as a powder, the structures may undergo mechanical disruption to enhance the surface treatment and/or achieve a more thorough treatment. As specific examples, the structures may be stirred, shaken, ball-milled, blown or otherwise dispersed. Other treatment methods may include X-ray radiation or ultraviolet (UV) radiation.

As noted above, the method can also be applied to modify the surface of various types of positive electrode active materials. Classes of positive electrode active materials include LiMO₂, LiMPO₄, LiM₂O₄, a lithium metal silicide, such as LiMgxSi_{y}, MSₓ (metal sulfide), MₓO_{y} (metal oxide) where M is a metal such as V, Mn, Fe, Co, Ni, Al, Si, or a combination thereof. Examples of lithium metal oxides include LiCoO₂, LiMn₂O₄, lithium nickel oxides such as LiNiO₂, LiNiₓCo₁₋ₓO₂, LiNiₓCo_{y}Mn_{(1-x-y)}O₂, LiNiₓCo_{y}Al_{(1-x-y)}O₂ whereas 0<x<1, 0<y<1, lithium metal phosphates, and lithium mixed metal phosphates such as LiFePO₄, LiMnPO₄, LiCoPO₄, LiFeₓMn₁₋ₓPO₄, LiNiₓMn₁₋ₓO₄. For example, the addition of multivalent metal salts may reduce the sulfur dissolution in metal sulfide positive electrode active materials. The addition of the multivalent metal salts may improve the coulombic efficiency of the charge-discharge process. In some examples, the method may also be applied to decrease the amount of remaining moisture in materials, electrodes or cells before filling them with electrolyte.

Specific groups of electrode active materials include a group of titanium containing materials and a group of nickel containing materials. Both groups of these materials are believed to be responsible for significant gas evolution if these materials are not treated in accordance with techniques described above. Specific examples of the titanium containing materials include LTO and variations thereof.

In one example, an electrode active material for use in a lithium ion battery comprising an electrode active material for intercalating and deintercalating lithium ions is provided. The electrode active material may comprise oxygen and a multivalent metal salt. For example, the electrode active material may be a lithium metal oxide. In another example, the electrode active material may be a negative electrode active material, for example lithium titanate. The multivalent metal ion of the multivalent metal ion layer may be one of the following multivalent metal ions: Ba, Ca, Ce, Cs, Co, Cu, La, Mg, Mn, Ni, Nb, Ag, Ti, Al, An, Ur, Pb, Fe, Hg, and Gd. The multivalent metal ion may be provided by one of the following multivalent metal salts: manganese bis(trifluoromethanesulfonyl) imide (Mn(N(SO₂CF₃)₂)₂), magnesium bis(trifluoromethanesulfonyl) imide (Mg(N(SO₂CF₃)₂)₂), calcium bis(trifluoromethanesulfonyl) imide (Ca(N(SO₂CF₃)₂)₂), cobalt bis(trifluoromethanesulfonyl)imide (Co(N(SO₂CF₃)₂)₂), nickel bis(trifluoromethanesulfonyl) imide (Ni(N(SO₂CF₃)₂)₂), copper bis(trifluoromethanesulfonyl) imide (Cu(N(SO₂CF₃)₂)₂), zinc bis(trifluoromethanesulfonyl) imide (Zn(N(SO₂CF₃)₂)₂), cesium bis(trifluoromethanesulfonyl)imide (Cs(N(SO₂CF₃)₂)₂), barium bis(trifluoromethanesulfonyl) imide (Ba(N(SO₂CF₃)₂)₂), lanthanum bis(trifluoromethanesulfonyl)imide (La(N(SO₂CF₃)₂)₂), and cerium bis(trifluoromethanesulfonyl)imide (Ce(N(SO₂CF₃)₂)₂). An amount of the multivalent metal salt may be 0.2% by weight to 20% by weight relative to a weight of the electrode active material. The multivalent metal ion layer may be a direct conformal layer on the electrode active material, for example as discussed regarding FIGS. 2A, 2B, and 2C. Further, the direct conformal layer may be an ionically conductive layer.

The multivalent metal ion may be selected based on their electrochemical potential being higher than a potential of the electrode active material versus lithium. The multivalent metal ion layer may be covalently bound to the electrode active material, wherein the covalently bound multivalent metal ion forms a metal ion-divalent anion link.

### Examples of Electrochemical Cells

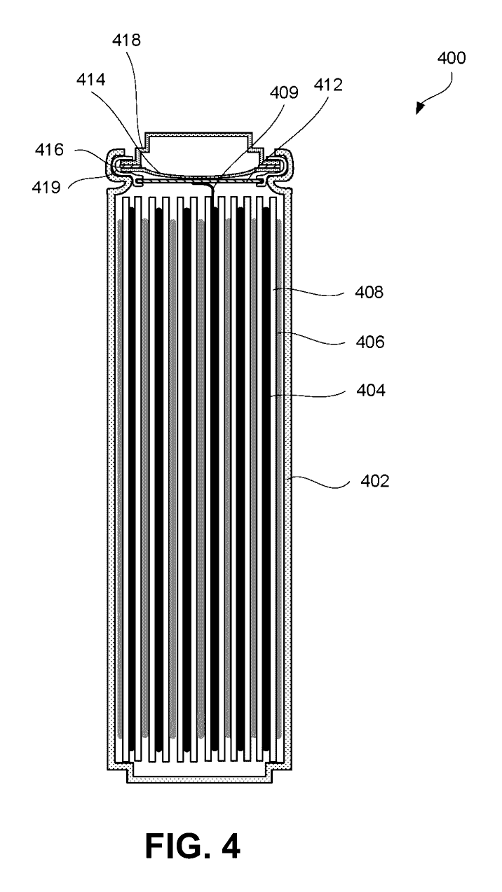

A brief description of a cell is provided for better understanding of some electrolyte features as well as components that come in contact with electrolyte and expose electrolyte to certain potentials. FIG. 4 illustrates a schematic cross-sectional view of a cylindrical wound cell 400, in accordance with some embodiments. Positive electrode 406, negative electrode 404, and separator strips 408 may be wound into a jelly roll, which is inserted into a cylindrical case 402. The jelly roll is a spirally wound assembly of positive electrode 406, negative electrode 404, and two separator strips 408. The jelly roll is formed into a shape of case 402 and may be cylindrical for cylindrical cells and a flattened oval for prismatic cells. Other types of electrode arrangements include stacked electrodes that may be inserted into a hard case or a flexible case.

The electrolyte (not shown) is supplied into case 402 prior to sealing cell 400. The electrolyte soaks into positive electrode 406, negative electrode 404, and separator strip 408, all of which are porous components. The electrolyte provides ionic conductivity between positive electrode 406 and negative electrode 404. As such, the electrolyte is exposed to the operating potentials of both electrodes and comes in contact with essentially all internal components of cell 400. The electrolyte should be stable at these operating potentials and should not damage the internal components.

Case 402 may be rigid (in particular for lithium ion cells). Other types of cells may be packed into a flexible, foil-type (polymer laminate) case. For example, pouch cells are typically packed into a flexible case. A variety of materials can be chosen for case 402. Selection of these materials depends in part on an electrochemical potential to which case 402 is exposed. More specifically, the selection depends on which electrode, if any, case 402 is connected to and what the operating potentials are of this electrode.

If case 402 is connected to positive electrode 406 of a lithium ion battery, then case 402 may be formed from titanium 6-4, other titanium alloys, aluminum, aluminum alloys, and 300-series stainless steel. On the other hand, if case 402 is connected to negative electrode 404 of the lithium ion battery, then case 402 may be made from titanium, titanium alloys, copper, nickel, lead, and stainless steels. In some embodiments, case 402 is neutral and may be connected to an auxiliary electrode made, for example, from metallic lithium. An electrical connection between case 402 and an electrode may be established by a direct contact between case 402 and this electrode (e.g., an outer wind of the jelly roll), by a tab connected to the electrode and case 402, and other techniques. Case 402 may have an integrated bottom as shown in FIG. 3. Alternatively, a bottom may be attached to the case by welding, soldering, crimping, and other techniques. The bottom and the case may have the same or different polarities (e.g., when the case is neutral).

The top of case 402, which is used for insertion of the jelly roll, may be capped with a header assembly that includes a weld plate 412, a rupture membrane 414, a PTC washer 416, header cup 418, and insulating gasket 419. Weld plate 412, rupture membrane 414, PTC washer 416, and header cup 418 are all made from conductive material and are used for conducting electricity between an electrode (negative electrode 404 in FIG. 3) and a cell connector. Insulating gasket 419 is used to support the conductive components of the header and insulate these components from case 402. Weld plate 412 may be connected to the electrode by tab 409. One end of tab 409 may be welded to the electrode (e.g., ultrasonic or resistance welded), while the other end of tab may be welded to weld plate 412. Centers of weld plate 412 and rupture membrane 414 are connected due to the convex shape of rupture membrane 414. If the internal pressure of cell 400 increases (e.g., due to electrolyte decomposition and other outgassing processes), rupture membrane 414 may change its shape and disconnect from weld plate 412, thereby breaking the electrical connection between the electrode and the cell connector.

PTC washer 416 is disposed between edges of rupture membrane 414 and edges of header cup 418 effectively interconnecting these two components. At normal operating temperatures, the resistance of PTC washer 416 is low. However, its resistance increases substantially when PTC washer 416 is heated up due to, e.g., heat released within cell 400. PTC washer 416 is effectively a thermal circuit breaker that can electrically disconnect rupture membrane 414 from header cup 418 and, as a result, disconnect the electrode from the cell connector when the temperature of PTC washer 416 exceeds a certain threshold temperature. In some embodiments, a cell or a battery pack may use a negative thermal coefficient (NTC) safety device in addition to or instead of a PTC device.

Also provided herein are battery packs, each containing one or more electrochemical cells built with processed electrode active materials. When a battery pack includes multiple cells, these cells may be configured in series, in parallel, or in various combinations of these two connection schemes. In addition to cells and interconnects (electrical leads), battery packs may include charge/discharge control systems, temperature sensors, current balancing systems, and other like components. For example, battery regulators may be used to keep the peak voltage of each individual cell below its maximum value so as to allow weaker batteries to be fully charged, thereby bringing the whole pack back into balance. Active balancing can also be performed by battery balancer devices that can shuttle energy from stronger batteries to weaker ones in real time for improved balance.

In one example, a non-aqueous electrolyte battery comprising a cathode, an anode, an electrolyte solution, and a separator positioned between the anode and the cathode may be provided. The cathode may comprise a positive electrode active material in contact with a cathode current collector for intercalating and deintercalating lithium ions. The anode may comprise a negative electrode active material in contact with an anode current collector for intercalating and deintercalating lithium ions. Further, the positive electrode active material, the negative electrode active material, or both may comprise oxygen. The electrolyte solution may comprise at least one salt and at least one solvent. The electrolyte solution being in ionically conductive contact with the anode and the cathode. The non-aqueous electrolyte battery further comprises a multivalent metal ion layer on at least one of the positive electrode active material or the negative electrode active material, wherein the multivalent metal ion layer is an ionically conductive layer. The multivalent metal in layer includes a multivalent metal ion forming a covalent bond with an oxygen in at least one of the positive electrode active material or the negative electrode active material. The multivalent metal ion is provided by a multivalent metal salt, wherein the multivalent metal ion forms a direct conformal layer. For example, the negative electrode active material may be lithium titanate. The covalently bound multivalent metal ion may form a metal ion-divalent link.

### Electrode Active Materials and Electrolytes

In certain embodiments, a positive electrode includes one or more electrode active materials and a current collecting substrate. The positive electrode may have an upper charging voltage of about 3.5-4.5 volts versus a Li/Li⁺ reference electrode. The upper charging voltage is the maximum voltage to which the positive electrode may be charged at a low rate of charge and with significant reversible storage capacity. In some embodiments, cells utilizing a positive electrode with upper charging voltages from about 3-5.8 volts versus a Li/Li⁺ reference electrode are also suitable. In certain instances, the upper charging voltages are from about 3-4.2 volts, about 4.0-5.8 volts, or about 4.5-5.8 volts. In certain instances, the positive electrode has an upper charging voltage of about 5 volts. For example, the cell can have an upper charging voltage of about 4.9, 5.0, 5.1, 5.2, 5.3, 5.4, 5.5, 5.6, 5.7 or 5.8 volts. A variety of positive electrode active materials can be used. Non-limiting illustrative electrode active materials include transition metal oxides, phosphates and sulfates, and lithiated transition metal oxides, phosphates and sulfates.

In some embodiments, the electrode active materials are oxides with empirical formula LixMO₂, where M is a transition metal selected from Mn, Fe, Co, Ni, Al, Mg, Ti, V, Si of a combination thereof, with a layered crystal structure. The value x may be between about 0.01 and about 1, between about 0.5 and about 1, or between about 0.9 and about 1.

In other embodiments, the electrode active materials are oxides with the formula LiₓM1ₐM2_{b}M3_{c}O₂, where M1, M2, and M3 are each independently a transition metal selected from the group Mn, Fe, Co, Ni, Al, Mg, Ti, V or Si. The subscripts a, b and c are each independently a real number between about 0 and 1 (0≦a≦1; 0≦b≦1; 0≦c≦1; 0.01≦x≦1), with the proviso that a+b+c is about 1.

In certain instances, the electrode active materials are oxides with the empirical formula LiₓNiₐCo_{b}Mn_{c}O₂, wherein the subscript x is between about 0.01 and 1 (e.g., x is 1); the subscripts a, b and c are each independently 0, 0.1, 0.2, 0.3, 0.4, 0.5, 0.6, 0.7, 0.9 or 1, with the proviso that a+b+c is 1. In other instances, the subscripts a, b and c are each independently between about 0-0.5, between about 0.1-0.6, between about 0.4-0.7, between about 0.5-0.8, between about 0.5-1 or between about 0.7-1 with the proviso that a+b+c is about 1.

In yet other embodiments, the electrode active materials are oxides with the empirical formula Li₁₊ₓA_{y}M_{2-y}O₄, where A and M are each independent transition metal selected from Fe, Mn, Co, Ni, Al, Mg, Ti, V, Si, and a combination thereof, with a spinel crystal structure. The value x may be between about −0.11 and 0.33, or between about 0 and about 0.1. The value of y may be between about 0 and 0.33, or between 0 and about 0.1. In one embodiment, A is Ni, x is 0 and y is 0.5 (i.e., the electrode active material is LiA_{0.5}M_{1.5}O₄).

In yet some other embodiments the electrode active materials are vanadium oxides such as LiV₂O₅, LiV₆O₁₃, or the foregoing compounds modified in that the compositions thereof are nonstoichiometric, disordered, amorphous, overlithiated or underlithiated.

The suitable positive electrode-active compounds may be further modified by doping with about 5% or less of divalent or trivalent metallic cations such as Fe²⁺, Ti²⁺, Zn²⁺, Ni²⁺, Co²⁺, Cu²⁺, Mg²⁺, Cr³⁺, Fe³⁺, Al³⁺, Ni³⁺ Co³⁺, or Mn³⁺, and the like. In other embodiments, positive electrode active materials suitable for the positive electrode composition include lithium insertion compounds with olivine structure such as LixMXO₄, where M is a transition metal selected from Fe, Mn, Co, Ni, and a combination thereof, X is selected from P, V, S, Si and combinations thereof, and the value of x is between about 0 and 2. In certain instances, the compound is LiMXO₄. In some embodiments, the lithium insertion compounds include LiMnPO₄, LiVPO₄, LiCoPO₄ and the like. In other embodiments, the electrode active materials have NASICON structures such as YₓM₂(XO₄)₃, where Y is Li or Na, or a combination thereof, M is a transition metal ion selected from Fe, V, Nb, Ti, Co, Ni, Al, or the combinations thereof, X is selected from P, S, Si, and combinations thereof, and the value of x is between 0 and 3. Particle size of the electrode materials may be between about 1 nm and about 100 μm, or between about 10 nm and about 100 μm, or between about 1 μm and 100 μm.

In other embodiments, the electrode active materials are oxides such as LiCoO₂, spinel LiMn₂O₄, chromium-doped spinel lithium manganese oxides LiₓCr_{y}Mn₂O₄, layered LiMn₂O₄, LiNiO₂, or LiNiₓCo₁₋ₓO₂, where x is between about 0 and 1, or between about 0.5 and about 0.95. The electrode active materials may also be vanadium oxides such as LiV₂O₅, LiV₆O₁₃, or the foregoing compounds modified in that the compositions thereof are nonstoichiometric, disordered, amorphous, overlithiated or underlithiated.

The suitable positive electrode active compounds may be further modified by doping with about 5% or less of divalent or trivalent metallic cations such as Fe²⁺, Ti²⁺, Zn²⁺, Ni²⁺, Co²⁺, Cu²⁺, Mg²⁺, Cr³⁺, Al³⁺, Ni³⁺ Co³⁺, or Mn³⁺, and the like. In yet other embodiments, positive electrode active materials suitable for the positive electrode composition include lithium insertion compounds with olivine structure such as LiFePO₄ and with NASICON structures such as LiFeTiMn(SO₄)₃. In still other embodiments, electrode active materials include LiFePO₄, LiMnPO₄, LiVPO₄, LiFeTi(SO₄)₃, LiNiₓMn₁₋ₓO₂, LiNiₓCo_{y}Mn_{1-x-y}O₂ and derivatives thereof, wherein x and y are each between about 0 and 1. In certain instances, x is between about 0.25 and 0.9. In one instance, x is ⅓ and y is ⅓. Particle size of the positive electrode active material should range from about 1 to 100 microns.

In some embodiments, the electrode active material includes transition metal oxides such as LiCoO₂, LiMn₂O₄, LiNiO₂, LiNiₓMn₁₋ₓO₂, LiNiₓCo_{y}Mn_{1-x-y}O₂ and their derivatives, where x and y are each between about 0 and 1. LiNiₓMn₁₋ₓO₂ can be prepared by heating a stoichiometric mixture of electrolytic MnO₂, LiOH and nickel oxide to between about 300 and 400° C. In certain embodiments, the electrode active materials are xLi₂MnO₃(1−x)LiMO₂ or LiM′PO₄, where M is selected Ni, Co, Mn, LiNiO₂ or LiNiₓCo₁₋ₓO₂; M′ is selected from Fe, Ni, Mn and V; and x and y are each independently a real number between about 0 and 1. LiNiₓCo_{y}Mn_{1-x-y}O₂ can be prepared by heating a stoichiometric mixture of electrolytic MnO₂, LiOH, nickel oxide and cobalt oxide to between about 300° C. and 500° C. The positive electrode may contain conductive additives from 0% to about 90%. In one embodiment, the subscripts x and y are each independently selected from 0.1, 0.15, 0.2, 0.25, 0.3, 0.35, 0.4, 0.45, 0.5, 0.55, 0.6, 0.65, 0.7, 0.75, 0.8, 0.85, 0.9 or 0.95, and x and y can be any numbers between 0 and 1 to satisfy the charge balance of the compounds LiNiₓMn₁₋ₓO₂ and LiNiₓCo_{y}Mn_{1-x-y}O₂.

Representative positive electrodes and their approximate recharged potentials include FeS₂ (3.0 V vs. Li/Li⁺), LiCoPO₄ (4.8 V vs. Li/Li⁺), LiFePO₄ (3.45 V vs. Li/Li⁺), Li₂FeS₂ (3.0 V vs. Li/Li⁺), Li₂FeSiO₄ (2.9 V vs. Li/Li⁺), LiMn₂O₄ (4.1 V vs. Li/Li⁺), LiMnPO₄ (4.1 V vs. Li/Li⁺), LiNiPO₄ (5.1 V vs. Li/Li⁺), LiV₃O₈ (3.7 V vs. Li/Li⁺), LiV₆O₁₃ (3.0 V vs. Li/Li⁺), LiVOPO₄ (4.15 V vs. Li/Li⁺), LiVOPO₄F (4.3 V vs. Li/Li⁺), Li₃V₂(PO₄)₃ (4.1 V (2 Li) or 4.6 V (3 Li) vs. Li/Li⁺), MnO₂ (3.4 V vs. Li/Li⁺), MoS₃ (2.5 V vs. Li/Li⁺), sulfur (2.4 V vs. Li/Li⁺), TiS₂ (2.5 V vs. Li/Li⁺), TiS₃ (2.5 V vs. Li/Li⁺), V₂O₅ (3.6 V vs. Li/Li⁺), and V₆O₁₃ (3.0 V vs. Li/Li⁺) and combinations thereof.

A positive electrode can be formed by mixing and forming a composition including, by weight, between about 0.01-15% (e.g., between about 4-8%) polymer binder, between about 10-50% (e.g., between about 15-25%) electrolyte solution as herein described, between about 40-85% (e.g., between about 65-75%) electrode-electrode active material, and between about 1-12% (e.g., between about 4-8%) conductive additive. An inert filler may also be added up to about 12% by weight, though in certain cases no inert filler is used. Other additives may be included as well.

A negative electrode may include electrode active materials and a current collecting substrate. The negative electrode includes either a metal selected from Li, Si, Sn, Sb, Al and a combination thereof, or a mixture of one or more negative electrode active materials in particulate form, a binder (in certain cases a polymeric binder), optionally an electron conductive additive, and at least one organic carbonate. Examples of useful negative electrode active materials include, but are not limited to, lithium metal, carbon (graphites, coke-type, mesocarbons, polyacenes, carbon nanotubes, carbon fibers, and the like), and LTO. Negative electrode-electrode active materials also include lithium-intercalated carbon, lithium metal nitrides such as Li_{2.6}Co_{0.4}N, metallic lithium alloys such as LiAl, Li₄Sn, or lithium-alloy-forming compounds of tin, silicon, antimony, or aluminum. Further included as negative electrode-electrode active materials are metal oxides such as titanium oxides, iron oxides, or tin oxides.

Suitable materials for negative electrodes include lithium titanate (LTO), silicon, carbon, and other like materials. Specifically, lithium titanate, represented by the formula Li₄Ti₅O₁₂ (or Li_{4/3}Ti_{5/3}O₄), is one of the most promising materials for negative electrodes of lithium ion cells and lithium polymer cells. Lithium titanate may have varying ratios of lithium to titanium, such as LiₓTi_{y}O₄, wherein 0.8≦X≦1.4 and 1.6≦Y≦2.2 or X+Y˜3. The lithium titanate may be a stoichiometric or have a defect spinel configuration. In the defect spinel configuration, the distribution of lithium can vary. Lithium titanate has an excellent cycle life due to uniquely low volume change during charge and discharge resulting from a cubic spinel structure of the material. The lattice parameter of the cubic spinel structure (cubic, Sp. Gr. Fd-3m (227)) varies from 8.3595 Angstroms to 8.3538 Angstroms for extreme states during charging and discharging. This linear parameter change is equal to a volume change of about 0.2%. Lithium titanate has an electrochemical potential versus elemental lithium of about 1.55 V and can be intercalated with lithium to produce an intercalated lithium titanate represented by the formula Li₇Ti₅O₁₂. The intercalated lithium titanate has a theoretical capacity of about 175 mAh/g.

Lithium titanate also has a flat discharge curve. The charge and discharge processes of this electrode active material are believed to take place in a two-phase system. Li₄Ti₅O₁₂ has a spinel structure and, during charging, transforms into Li₇Ti₅O₁₂, which has an ordered rock-salt type structure. As a result, the electric potential during the charge and discharge processes is determined by electrochemical equilibrium between Li₄Ti₅O₁₂ and Li₇Ti₅O₁₂ and is not dependent on the lithium concentration. This is in contrast to the discharge curve of most other electrode materials for lithium power sources, which maintain their structure during the charge and discharge processes. For example, a structural transition of a charged phase in most positive electrode active materials, such as LiCoO₂, is pre-determined. However, there is still an extended limit of variable composition of LiₓCoO₂ between various structures that it can take. As a result, the electrical potential of such materials depends on the lithium concentration in the electrode active materials or, in other words, a state of charge or discharge. Thus, a discharge curve in materials in which the electrical potential is dependent on the lithium concentration in the material is typically inclined and is often a step-like curve.

Furthermore, lithium titanate has a low intrinsic electronic conductivity and lithium-ion diffusion coefficient, which may negatively impact high-rate charge/discharge capabilities. Doping and combining with other more conductive materials, such as carbon, may help to improve the electrochemical performance of this material.

When present in particulate form, the particle size of the negative electrode active material should range from about 0.01 to 100 microns (e.g., from about 1 to 100 microns). In some cases, the negative electrode active materials include graphites such as carbon microbeads, natural graphites, carbon nanotubes, carbon fibers, or graphitic flake-type materials. Alternatively or in addition, the negative electrode active materials may be graphite microbeads and hard carbon, which are commercially available.

A negative electrode can be formed by mixing and forming a composition including, by weight, between about 2-20% (e.g., 3-10%) polymer binder, between about 10-50% (e.g., between about 14-28%) electrolyte solution as described herein, between about 40-80% (e.g., between about 60-70%) electrode-electrode active material, and between about 0-5% (e.g., between about 1-4%) conductive additive. In certain cases, an inert filler is added up to about 12% by weight, although no filler is used in other cases. Additional additives may also be present.

Suitable conductive additives for the positive electrode and negative electrode composition include carbons such as coke, carbon black, carbon nanotubes, carbon fibers, and natural graphite, metallic flake or particles of copper, stainless steel, nickel or other relatively inert metals; conductive metal oxides such as titanium oxides or ruthenium oxides; or electrically-conductive polymers such as polyacetylene, polyphenylene and polyphenylenevinylene, polyaniline or polypyrrole. Additives may include, but are not limited to, carbon fibers, carbon nanotubes, and carbon blacks with a surface area below about 100 m²/g such as Super P and Super S carbon blacks available from MMM Carbon in Belgium.

The current collecting substrate suitable for the positive and negative electrode includes a metal foil and a carbon sheet selected from a graphite sheet, carbon fiber sheet, carbon foam, and carbon nanotube sheet or film. High conductivity is generally achieved in pure graphite and pure carbon nanotube films. Therefore, the graphite and nanotube sheeting should contain as few binders, additives, and impurities as possible in order to realize the benefits of the present embodiments. Carbon nanotubes can be present from about 0.01% to about 99% by weight. The carbon fiber can be in the micron or submicron range. Carbon black or carbon nanotubes may be added to enhance the conductivities of certain carbon fibers. In one embodiment, the negative electrode current collecting substrate is a metal foil, such as copper foil. The metal foil can have a thickness between about 5 and about 300 micrometers.

The carbon sheet current collecting substrate may be in the form of a powder coating on a substrate such as a metal substrate, a free-standing sheet, or a laminate. In other words, the current collecting substrate may be a composite structure having other members such as metal foils, adhesive layers, and such other materials as may be considered desirable for a given application. However, in any event, according to the present embodiments, it is the carbon sheet layer, or carbon sheet layer in combination with an adhesion promoter, which directly interfaces with the electrolyte and is in electrically conductive contact with the electrode surface.

Suitable binders include, but are not limited to, polymeric binders, particularly gelled polymer electrolytes including polyacrylonitrile, poly(methylmethacrylate), poly(vinyl chloride), and polyvinylidene fluoride, carboxymethylcellulose, and copolymers thereof. Also included are solid polymer electrolytes such as polyether-salt based electrolytes including poly(ethylene oxide) (PEO) and its derivatives, poly(propylene oxide) (PPO) and its derivatives, and poly(organophosphazenes) with ethyleneoxy or other side groups. Other suitable binders include fluorinated ionomers including partially or fully fluorinated polymer backbones, and having pendant groups including fluorinated sulfonate, imide, or methide lithium salts. Specific examples of binders include polyvinylidene fluoride and copolymers thereof with hexafluoropropylene, tetrafluoroethylene, fluorovinyl ethers, such as perfluoromethyl, perfluoroethyl, or perfluoropropyl vinyl ethers; and ionomers including monomer units of polyvinylidene fluoride and monomer units including pendant groups including fluorinated carboxylate, sulfonate, imide, or methide lithium salts.

The electrochemical cell optionally contains an ion conductive layer or a separator. The ion conductive layer suitable for the lithium or lithium-ion battery of the present embodiments is any ion-permeable layer, preferably in the form of a thin film, membrane or sheet. Such ion conductive layer may be an ion conductive membrane or a microporous film such as a microporous polypropylene, polyethylene, polytetrafluoroethylene and layered structures thereof. Suitable ion conductive layers also include swellable polymers such as polyvinylidene fluoride and copolymers thereof. Other suitable ion conductive layers include gelled polymer electrolytes such as poly(methyl methacrylate) and poly(vinyl chloride). Also suitable are polyethers such as poly(ethylene oxide) and poly(propylene oxide). In some cases, preferable separators are microporous polyolefin separators or separators including copolymers of vinylidene fluoride with hexafluoropropylene, perfluoromethyl vinyl ether, perfluoroethyl vinyl ether, or perfluoropropyl vinyl ether, including combinations thereof, or fluorinated ionomers.

An electrolyte may include various carbonates, such as cyclic carbonates and linear carbonates. Some examples of cyclic carbonates include ethylene carbonate (EC), propylene carbonate (PC), butylene carbonate (BC), vinylene carbonate (VC), dimethylvinylene carbonate (DMVC), vinylethylene carbonate (VEC), and fluoroethylene carbonate (FEC). The cyclic carbonate compounds may include at least two compounds selected from ethylene carbonate, propylene carbonate, vinylene carbonate, vinylethylene carbonate, and fluoroethylene carbonate. Some examples of linear-carbonate compounds include linear carbonates having an alkyl group, such as dimethyl carbonate (DMC), methyl ethyl carbonate (MEC), diethyl carbonate (DEC), methyl propyl carbonate (MPC), dipropyl carbonate (DPC), methyl butyl carbonate (MBC) and dibutyl carbonate (DBC). The alkyl group can have a straight or branched chain structure.

Examples of other non-aqueous solvents include lactones such as gamma-butyrolactone (GBL), gamma-valerolactone, and alpha-angelica lactone; ethers such as tetrahydrofuran, 2-methyltetrahydrofuran, 1,4-dioxane, 1,2-dimethoxyethane, 1,2-diethoxyethane, and 1,2-dibutoxyethane; nitriles such as acetonitrile, and adiponitrile; linear esters such as methyl propionate, methyl pivalate, butyl pivalate, hexyl pivalate, octyl pivalate, dimethyl oxalate, ethyl methyl oxalate, and diethyl oxalate; amides such as dimethylformamide; and compounds having an S═O bonding such as glycol sulfite, propylene sulfite, glycol sulfate, propylene sulfate, divinyl sulfone, 1,3-propane sultone, 1,4-butane sultone, and 1,4-butanediol dimethane sulfonate.

Examples of combinations of the non-aqueous solvents include a combination of a cyclic carbonate and a linear carbonate; a combination of a cyclic carbonate and a lactone; a combination of a cyclic carbonate, a lactone and a linear ester; a combination of a cyclic carbonate, a linear carbonate, and a lactone; a combination of a cyclic carbonate, a linear carbonate, and an ether; and a combination of a cyclic carbonate, a linear carbonate, and a linear ester. Preferred are the combination of a cyclic carbonate and a linear carbonate, and the combination of a cyclic carbonate, a linear carbonate, and a linear ester.

Examples of electrolyte salts used in non-aqueous electrolytic solutions include: LiPF₆, LiBF₄, LiClO₄; lithium salts including a chain alkyl group such as LiN(SO₂CF₃)₂, LiN(SO₂C₂F₅)₂, LiC(SO₂CF₃)₃, LiPF₄(CF₃)₂, LiPF₃(C₂F₅)₃, LiPF₃(CF₃)₃, LiPF₃(iso-C₃F₇)₃, and LiPF₅(iso-C₃F₇); and lithium salts including a cyclic alkylene group such as (CF₂)₂(SO₂)₂NLi, and (CF₂)₃(SO₂)₂NLi. More preferred are LiPF₆, LiBF₄ and LiN(SO₂CF₃)₂, and most preferred is LiPF₆, though these preferential ingredients are in no way limiting.

The electrolyte salt can be used singly or in combination. Examples of the preferred combinations include a combination of LiPF₆ with LiBF₄, a combination of LiPF₆ with LiN(SO₂CF₃)₂, and a combination of LiBF₄ with LiN(SO₂CF₃)₂. Most preferred is the combination of LiPF₆ with LiBF₄, though again, these preferential combinations are in no way limiting. There is no specific limitation with respect to the mixing ratio of the two or more electrolyte salts. In the case that LiPF₆ is mixed with other electrolyte salts, the amount of the other electrolyte salts preferably is about 0.01 mole % or more, about 0.03 mole % or more, about 0.05 mole % or more based on the total amount of the electrolyte salts. The amount of the other electrolyte salts may be about 45 mole % or less based on the total amount of the electrolyte salts, about 20 mole % or less, about 10 mole % or less, or about 5 mole % or less. The concentration of the electrolyte salts in the non-aqueous solvent may be about 0.3 M or more, about 0.5 M or more, about 0.7 M or more, or about 0.8 M or more. Further, the electrolyte salt concentration preferably is about 2.5 M or less, about 2.0 M or less, about 1.6 M or less, or about 1.2 M or less.

In some embodiments, the multivalent metal salt may be included in the electrolyte. For example, the multivalent metal salt may be selected from the group consisting of manganese bis(trifluoromethanesulfonyl) imide (Mn(N(SO₂CF₃)₂)₂), magnesium bis(trifluoromethanesulfonyl) imide (Mg(N(SO₂CF₃)₂)₂), calcium bis(trifluoromethanesulfonyl) imide (Ca(N(SO₂CF₃)₂)₂), cobalt bis(trifluoromethanesulfonyl)imide (Co(N(SO₂CF₃)₂)₂), nickel bis(trifluoromethanesulfonyl) imide (Ni(N(SO₂CF₃)₂)₂), copper bis(trifluoromethanesulfonyl) imide (Cu(N(SO₂CF₃)₂)₂), zinc bis(trifluoromethanesulfonyl) imide (Zn(N(SO₂CF₃)₂)₂), cesium bis(trifluoromethanesulfonyl)imide (Cs(N(SO₂CF₃)₂)₂), barium bis(trifluoromethanesulfonyl) imide (Ba(N(SO₂CF₃)₂)₂), lanthanum bis(trifluoromethanesulfonyl)imide (La(N(SO₂CF₃)₂)₂), and cerium bis(trifluoromethanesulfonyl)imide (Ce(N(SO₂CF₃)₂)₂).

### Experimental Results

Various experiments were conducted to determine effects of surface treatment using multivalent metal salts. The tested parameters included cycle life and capacity retention during storage. Two sets of electrochemical cells were prepared: a reference set and a test set. Both sets were fabricated using LTO-based negative electrodes and LMO-based positive electrodes.

A positive electrode was prepared using lithium manganese oxide (LMO), Super P, KS₆ graphite, and PVDF. A matching negative electrode was fabricated using a slurry formed from LTO powder (available from Hanwha in Seoul, South Korea), KS₆ graphite, Super P, PVDF, and N-Methyl-2-pyrrolidone. Thin film coatings were cast on both sides of 16 micrometer thick aluminum foil. Each side had a loading of 10 mg/cm². The coating film was then compressed to a density of 1.8 g/cm³.

Electrodes having a size of about 50 mm by 80 mm were punched from the pressed coated sheets. An uncoated strip of foil extended along one side of the electrode and used to attach tabs. The electrodes were then dried for 16 hours under a vacuum at 125° C. The electrodes were then arranged into stacks with a 20 micrometer thick polyethylene separator (available from W-Scope in Chungcheong-Do, Korea) and sealed in a laminated aluminum foil pouch. Each stack was disposed in a separate rectangular pouch with one side open and dried under a vacuum at 60° C. for 48 hours. The cells were then filled with electrolyte. The cells went through C/10 charge/discharge formation cycling with 1.5V and 2.7 V used as cut-off voltages, and were then vacuumed and sealed.

The cells in the reference set were filled with a base electrolyte that included 0.2M of LiN(CF₃SO₂)₂ and 0.8M of LiPF₆ dissolved in a combination of propylene carbonate and ethyl-methyl carbonate. The cells in the test set were filled with a modified electrolyte, which included 0.1M of Mn(N(SO₂CF₃)₂)₂ added to the base electrolyte. Thus, the test set includes the electrode active material comprising a multivalent metal ion wherein the multivalent metal ion is a direct conformal layer on the electrode active material. All cells were formed and tested at 60° C. The elevated temperature was chosen as an example of extreme operating conditions as well as a condition representing accelerated testing.

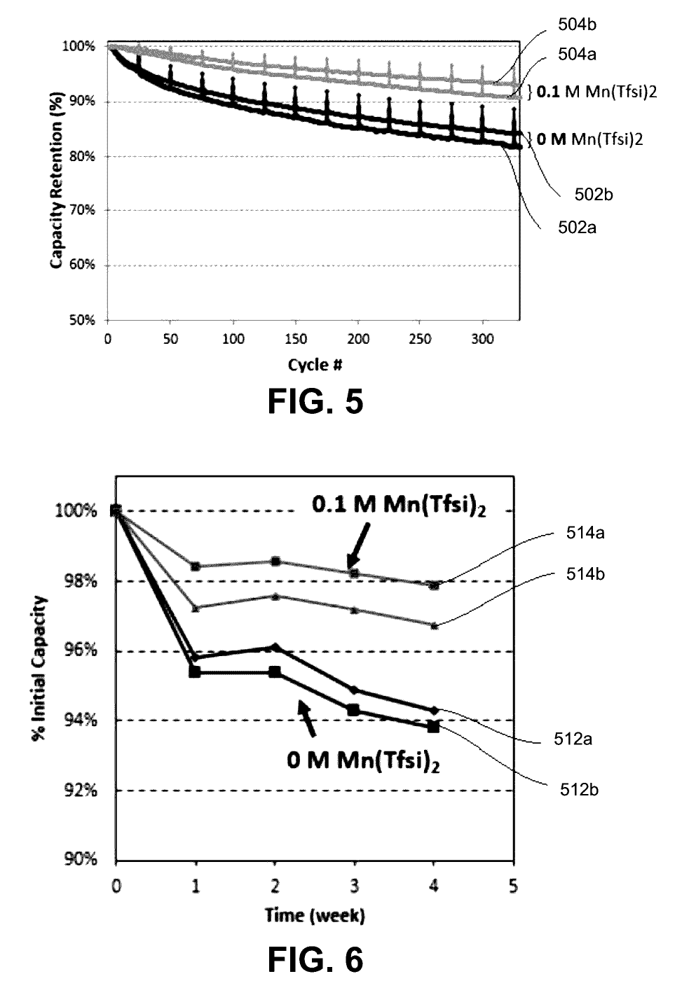

FIG. 5 illustrates cycle life data for the two sets of electrochemical cells. The test was performed at 60° C. using the 1C rate for charge and the 1C rate for discharge. The cut off voltages were 1.5V and 2.7 V. Lines 502a and 502b represent the reference cells, while lines 504a and 504b represent the test cells. After about 300 cycles, the test cells had about 10% better capacity retention than the reference cells, which is a significant improvement.

FIG. 6 illustrates calendar life/capacity retention data for the two sets of electrochemical cells. The test was performed at 60° C. and the cells were initially charged to 100% state of charge. Lines 512a and 512b represent the reference cells, while lines 514a and 514b represent the test cells. After 4 weeks, the test cells had about 3.5% on average higher capacity than the reference cells, which is also a significant improvement.

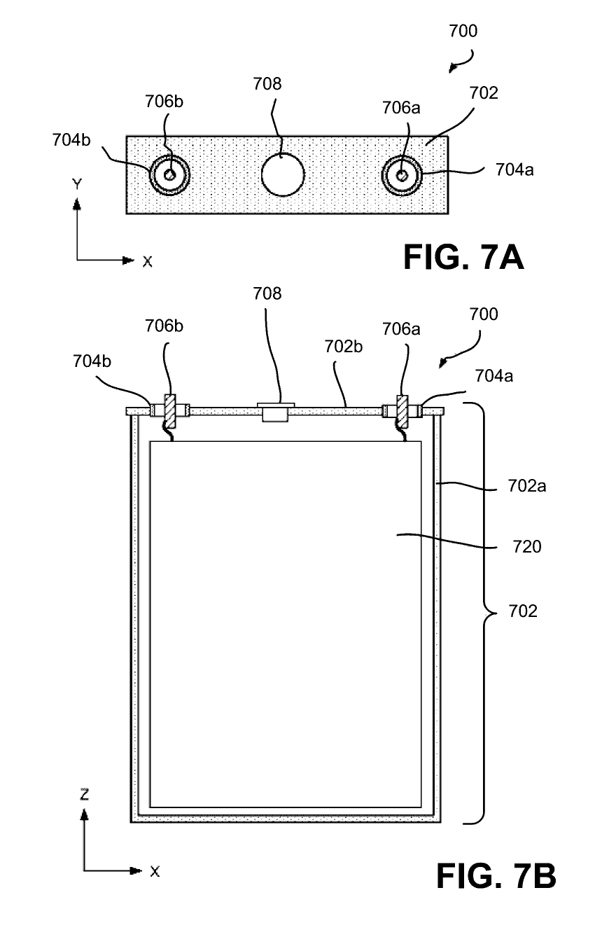

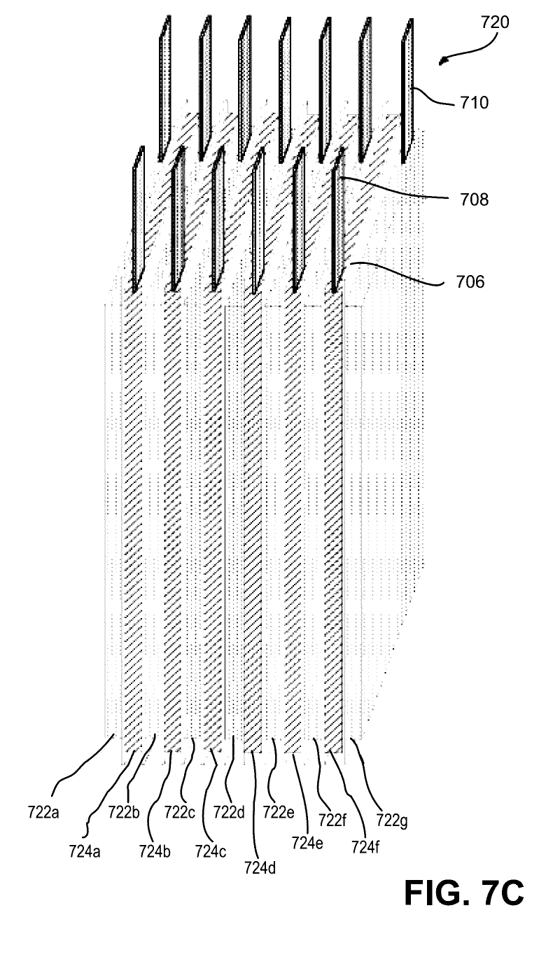

Turning to FIGS. 7A and 7B, a schematic top and side view of a prismatic electrochemical cell 700 are illustrated respectively, in accordance with certain embodiments. Electrochemical cell 700 includes an enclosure assembly 702 that surrounds and encloses an electrode assembly 720. Enclosure assembly 702 is shown to include a case 702a and header 702b attached to case 702a. Enclosure assembly 720 may include other components, such as a case bottom, various seals and insulating gaskets, which are not specifically shown in FIGS. 7A and 7B.

Header 702b is shown to include feed-through 704a and 704b and venting device 708. One of these components may be used as a fill plug. Feed-through 1904a and 1904b include corresponding conductive elements 706a and 706b that provide electronic communication to respective electrodes in electrode assembly 720 as further described with reference to FIG. 7C. In certain embodiments, external components of conductive elements 706a and 706b may be used as cell terminals for making electrical connections to the battery. Conductive elements 706a and 706b may be insulated from header 702b. In other embodiments, header 702b and/or 702a may provide one or both electronic paths to the electrodes in electrode assembly 720. In some embodiments, a cell may have only one feed-through or no feed-through at all.

In certain embodiments (not shown), the feed-through and/or venting device may be supported by other components of enclosure assembly 702, such as the case and/or bottom. Further, the feed-through and/or venting device may be integrated into a header or other components of the enclosure assembly during fabrication of these components or during assembly of the cell. The latter case allows more flexibility in design and production.

Components of enclosure assembly 702 may be made from electrically insulating materials, such as various polymers and plastics. These materials need to be mechanically/chemically/electrochemically stable at the specific operating conditions of the cell, including but not limited to electrolytes, operating temperature ranges, and internal pressure build-ups. Some examples of such materials include polyamine, polyethylene, polypropylene, polyimide, polyvinylidene fluoride, polytetrafluoroethylene, and polyethylene terephthalate. Other polymers and copolymers may be used as well. In certain embodiments, components of enclosure assembly 702 may be made from conductive materials. In these embodiments, one or more components may be used to provide electronic communication to the electrodes. When multiple conductive components are used for enclosure assembly 702, these conductive components may be insulated with respect to each other using insulating gaskets.

Conductive elements 706a and 706b may be made of various conductive materials such as any metal of metallic alloy. These conductive materials may be isolated from any contact with electrolyte (e.g., external components or components having protective sheaths) and/or electrochemically stable at operating potentials if exposed to electrolyte. Some examples of conductive materials include steel, nickel, aluminum, nickel, copper, lead, zinc and their alloys.

When enclosure assembly 702 includes multiple components, such as case 702a and header 702b, these components may be sealed with respect to each other. The sealing process used depends on the materials used for the components, and may involve heat sealing, adhesive application (e.g., epoxies), and/or welding (e.g., laser welding, ultrasonic welding, etc.). This sealing is performed after inserting electrode assembly 720 into enclosure assembly 702 and typically prior to filling electrolyte into enclosure assembly 702. Enclosure assembly 702 may be then sealed by installing venting device 708 or some other means. However, in certain embodiments the sealing may occur before electrolyte is introduced into the enclosure assembly 702. In such embodiments, the enclosure assembly 702 should provide a mechanism for filling electrolyte after such sealing has taken place. In one example, the enclosure assembly 702 includes a filling hole and plug (not shown).

Electrode assembly 720 includes at least one cathode and one anode. These two types of electrodes are typically arranged such that they face one another and extend alongside one another within the enclosure assembly 702. A separator may be provided between two adjacent electrodes to provide electric insulation while also allowing ionic mobility between the two electrodes through pores in the separator. The ionic mobility is provided by electrolyte that soaks the electrodes and separator.

The electrodes are typically much thinner than the internal spacing of enclosure assembly 702. In order to fill this space, electrodes may be arranged into stack and/or jelly rolls. In a jelly roll, one cathode and one anode are wound around the same axis (in the case of round cells) or around an elongated shape (in the case of prismatic cells). Each electrode has one or more current collecting tabs extending from that electrode to one of conductive elements 706a and/or 706b of feed-through 704a and/or 704b, or to some other conductive component or components for transmitting an electrical current to the electrical terminals of the cell.

In a stackable cell configuration, multiple cathodes and anodes may be arranged as parallel alternating layers. One example of a stackable electrode assembly 720 is shown in FIG. 7C. Electrode assembly 720 is shown to include seven cathodes 722a-722g and six anodes 724a-724f. Adjacent cathodes and anodes are separated by separator sheets 726 to electrically insulate the adjacent electrodes while providing ionic communication between these electrodes. Each electrode may include a conductive substrate (e.g., metal foil) and one or two electrode active material layers, for example, the surface-treated electrode active material described above, supported by the conductive substrate. Each negative electrode active material layer is paired with one positive electrode active material layer. In the example presented in FIG. 7C, outer cathodes 722a and 722g include only one positive electrode active material facing towards the center of electrode assembly 720. All other cathodes and anodes have two electrode active material layers. One having ordinary skill in the art would understand that any number of electrodes and pairing of electrodes may be used. Conductive tabs may be used to provide electronic communication between electrodes and conductive elements, for example. In certain embodiments, each electrode in electrode assembly 720 has its own tab. Specifically, electrodes 722a-722g are shown to have positive tabs 710 while anodes 724a-724f are shown to have negative tabs 708.

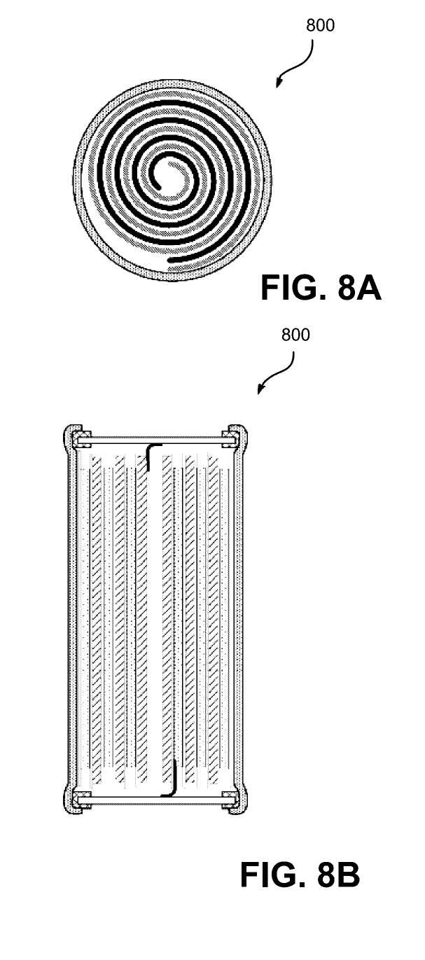

FIGS. 8A and 8B illustrate a schematic top and side view of a wound electrochemical cell example 800, in which two electrodes are wound into a jelly roll, in accordance with certain embodiments.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

Various modifications of the present invention, in addition to those shown and described herein, will be apparent to those skilled in the art of the above description. Such modifications are also intended to fall within the scope of the appended claims.

It is appreciated that all reagents are obtainable by sources known in the art unless otherwise specified.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular embodiments of the invention, but is not meant to be a limitation upon the practice thereof.

The foregoing discussion should be understood as illustrative and should not be considered limiting in any sense. While the inventions have been particularly shown and described with references to preferred embodiments thereof, it will be understood by those skilled in the art that various changes in form and details may be made therein without departing from the spirit and scope of the inventions as defined by the claims.

The corresponding structures, materials, acts and equivalents of all means or steps plus function elements in the claims below are intended to include any structure, material or acts for performing the functions in combination with other claimed elements as specifically claimed.

Finally, it will be understood that the articles, systems, and methods described hereinabove are embodiments of this disclosure—non-limiting examples for which numerous variations and extensions are contemplated as well. Accordingly, this disclosure includes all novel and non-obvious combinations and sub-combinations of the articles, systems, and methods disclosed herein, as well as any and all equivalents thereof.

1. A surface-treated electrode active material for use in a lithium ion battery, comprising:
an electrode active material having an outer surface; and
an ionically conductive layer comprising a multivalent metal wherein the ionically conductive layer is a direct conformal layer on the outer surface of the electrode active material.

2. The surface-treated electrode active material of claim 1, wherein the electrode active material is an anode comprising a lithiated metal oxide wherein the metal is selected from the group consisting of titanium, tin, niobium, vanadium, zirconium, indium, iron, and copper.

3. The surface-treated electrode active material of claim 1, wherein the electrode active material is a cathode comprising a lithiated metal oxide, wherein the metal oxide is selected from a group consisting of vanadium oxide, manganese oxide, iron oxide, cobalt oxide, nickel oxide, aluminum oxide, silicon oxide or a combination thereof; a lithium metal silicide; a lithium metal sulfide; a lithium metal phosphate; a lithium mixed metal phosphate; and lithium insertion compounds with olivine structure such as LiₓMXO₄, where M is a transition metal selected from Fe, Mn, Co, Ni, and a combination thereof, X is selected from P, V, S, Si and combinations thereof, and the value of x is between about 0 and 2.

4. The surface-treated electrode active material of claim 1, wherein the multivalent metal has a hydrogen overvoltage potential of more than 0.4V.

5. The surface-treated electrode active material of claim 1, wherein the multivalent metal is selected from the group consisting of: Ba, Ca, Ce, Co, Cu, La, Mg, Mn, Ni, Nb, Ag, Ti, Al, Zn, Pb, Fe, Hg, Cr, Cd, Sn, Pb, Sb, and Bi.

6. The surface-treated electrode active material of claim 5, wherein the multivalent metal is provided by a multivalent metal salt comprising an ion of the multivalent metal and a negative ion wherein the negative ion is selected from the group consisting of: hexafluorophosphate ion; tetrafluoroborate ion; chlorate ion; C(SO₂CF₃)₃⁻ ion; PF₄(CF₃)₂⁻ ion; PF₃(C₂F₅)₃⁻ ion; PF₃(CF₃)₃⁻ ion; PF₃(iso-C₃F₇)₃⁻ ion; PF₅(iso-C₃F₇)⁻ ion; imide ion wherein the imide ion is selected from one of bis(fluorosulfuryl) imide ion, bis(trifluoromethanesulfonyl) imide ion, bis(perfluoroethylsulfonyl) imide ion, linear imide ions having a general structure N(—SO₂—R)₂⁻, wherein at least one R is a fluorinated alkyl having a chain length of from 1 to 8, cyclic imide ions having a general structure N(—SO₂—R—)⁻, wherein R is fluorinated alkyl having a chain length of from 1 to 8; methide ion having a general structure C(—SO₂—R)₃⁻, wherein R is a fluorinated alkyl with a chain length of from 0 to 8; bisoxalatoborate; and difluorooxalatoborate.

7. The surface-treated electrode active material of claim 6, further comprising an amount of the multivalent metal salt between 0.2% by weight to 20% by weight relative to a weight of the electrode active material.

8. The surface-treated electrode active material of claim 1, wherein the multivalent metal is selected based on the multivalent metal electrochemical potential being higher than a potential of the electrode active material versus lithium.

9. The surface-treated electrode active material of claim 1, wherein the multivalent metal is in at least a partially reduced form on the outer surface of the electrode active material.

10. A non-aqueous electrolyte, comprising:
at least one non-aqueous solvent;
one or more lithium containing salts, selected from LiPF₆, LiBF₄, LiClO₄ LiAsF₆, LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), lithium salts having cyclic alkyl groups and combinations thereof; and
a multivalent metal salt having a concentration between about 0.01M and 0.2M wherein the multivalent metal salt comprises a multivalent metal ion having a valance of at least +2.

11. The non-aqueous electrolyte of claim 10, wherein the multivalent metal salt is selected from the group consisting of manganese bis(trifluoromethanesulfonyl) imide (Mn(N(SO₂CF₃)₂)₂), magnesium bis(trifluoromethanesulfonyl) imide (Mg(N(SO₂CF₃)₂)₂), calcium bis(trifluoromethanesulfonyl) imide (Ca(N(SO₂CF₃)₂)₂), cobalt bis(trifluoromethanesulfonyl)imide (Co(N(SO₂CF₃)₂)₂), nickel bis(trifluoromethanesulfonyl) imide (Ni(N(SO₂CF₃)₂)₂), copper bis(trifluoromethanesulfonyl) imide (Cu(N(SO₂CF₃)₂)₂), zinc bis(trifluoromethanesulfonyl) imide (Zn(N(SO₂CF₃)₂)₂), cesium bis(trifluoromethanesulfonyl)imide (Cs(N(SO₂CF₃)₂)₂), barium bis(trifluoromethanesulfonyl) imide (Ba(N(SO₂CF₃)₂)₂), lanthanum bis(trifluoromethanesulfonyl)imide (La(N(SO₂CF₃)₂)₂), and cerium bis(trifluoromethanesulfonyl)imide (Ce(N(SO₂CF₃)₂)₂).

12. The non-aqueous electrolyte of claim 10, wherein the multivalent metal salt comprises a multivalent metal ion and a negative ion wherein the multivalent metal ion is selected from the group consisting of Ba, Ca, Ce, Co, Cu, La, Mg, Mn, Ni, Nb, Ag, Ti, Al, Zn, Pb, Fe, Hg, Cr, Cd, Sn, Pb, Sb, and Bi; and wherein the negative ion is selected from the group consisting of hexafluorophosphate ion; tetrafluoroborate ion; chlorate ion; C(SO₂CF₃)₃⁻ ion; PF₄(CF₃)₂⁻ ion; PF₃(C₂F₅)₃⁻ ion; PF₃(CF₃)₃⁻ ion; PF₃(iso-C₃F₇)₃⁻ ion; PF₅(iso-C₃F₇)⁻ ion; imide ion wherein the imide ion is selected from one of bis(fluorosulfuryl) imide ion, bis(trifluoromethanesulfonyl) imide ion, bis(perfluoroethylsulfonyl) imide ion, linear imide ions having a general structure N(—SO₂—R)₂⁻, wherein at least one R is a fluorinated alkyl having a chain length of from 1 to 8, cyclic imide ions having a general structure N(—SO₂—R—)⁻, wherein R is fluorinated alkyl having a chain length of from 1 to 8; methide ion having a general structure C(—SO₂—R)₃⁻, wherein R is a fluorinated alkyl with a chain length of from 0 to 8; bisoxalatoborate; and difluorooxalatoborate.

13. The non-aqueous electrolyte of claim 10, wherein the concentration of the multivalent salt is between 0.05M to 0.10M.

14. A non-aqueous electrolyte battery, comprising:
a cathode comprising a positive electrode active material in contact with a cathode current collector;
an anode comprising a negative electrode active material in contact with an anode current collector;
a separator positioned between the anode and the cathode;
an electrolyte solution being in ionically conductive contact with the anode and the cathode, the electrolyte comprising at least one salt, at least one solvent, and at least one multivalent metal salt;
an ionically conductive layer comprising a multivalent metal on at least one of the positive electrode active material or the negative electrode active material.

15. The non-aqueous electrolyte battery of claim 14, wherein the anode comprise a negative electrode active material comprising a lithiated metal oxide, wherein the metal is selected from the group consisting of titanium, tin, niobium, vanadium, zirconium, indium, iron, and copper; and
the cathode comprises a positive electrode active material comprising a lithiated metal oxide, wherein the metal oxide is selected from the group consisting of vanadium oxide, manganese oxide, iron oxide, cobalt oxide, nickel oxide, aluminum oxide, silicon oxide or a combination thereof; a lithium metal silicide; a lithium metal sulfide; a lithium metal phosphate; a lithium mixed metal phosphate; lithium insertion compounds with olivine structure such as LiₓMXO₄, where M is a transition metal selected from Fe, Mn, Co, Ni, and a combination thereof, X is selected from P, V, S, Si and combinations thereof, and the value of x is between about 0 and 2.

16. The non-aqueous electrolyte battery 14, wherein the multivalent metal salt comprises a multivalent metal ion and a negative ion wherein the multivalent metal ion is selected from the group consisting of Ba, Ca, Ce, Co, Cu, La, Mg, Mn, Ni, Nb, Ag, Ti, Al, Zn, Pb, Fe, Hg, Cr, Cd, Sn, Pb, Sb, and Bi; and
wherein the negative ion is selected from the group consisting of hexafluorophosphate ion; tetrafluoroborate ion; chlorate ion; C(SO₂CF₃)₃⁻ ion; PF₄(CF₃)₂⁻ ion; PF₃(C₂F₅)₃⁻ ion; PF₃(CF₃)₃⁻ ion; PF₃(iso-C₃F₇)₃⁻ ion; PF₅(iso-C₃F₇)⁻ ion; imide ion wherein the imide ion is selected from one of bis(fluorosulfuryl) imide ion, bis(trifluoromethanesulfonyl) imide ion, bis(perfluoroethylsulfonyl) imide ion, linear imide ions having a general structure N(—SO₂—R)₂⁻, wherein at least one R is a fluorinated alkyl having a chain length of from 1 to 8, cyclic imide ions having a general structure N(—SO₂—R—)⁻, wherein R is fluorinated alkyl having a chain length of from 1 to 8; methide ion having a general structure C(—SO₂—R)₃⁻, wherein R is a fluorinated alkyl with a chain length of from 0 to 8; bisoxalatoborate; or difluorooxalatoborate.

17. A method for preparing a surface-treated electrode active material, comprising:
receiving an oxygen containing electrode active material;
preparing a solution comprising a multivalent metal salt; and
contacting the prepared solution with the oxygen containing electrode active material forming a surface layer comprising multivalent metal ions of the multivalent metal salt, the surface network disposed on a surface of the oxygen containing electrode active material.

18. The method of claim 17, wherein the anode comprise a negative electrode active material comprising a lithiated metal oxide, wherein the metal is selected from the group consisting of titanium, tin, niobium, vanadium, zirconium, indium, iron, and copper; and
wherein the cathode comprises a positive electrode active material comprising a lithiated metal oxide, wherein the metal oxide is selected from the group consisting of vanadium oxide, manganese oxide, iron oxide, cobalt oxide, nickel oxide, aluminum oxide, silicon oxide or a combination thereof; a lithium metal silicide; a lithium metal sulfide; a lithium metal phosphate; a lithium mixed metal phosphate; lithium insertion compounds with olivine structure such as LiₓMXO₄, where M is a transition metal selected from Fe, Mn, Co, Ni, and a combination thereof, X is selected from P, V, S, Si and combinations thereof, and the value of x is between about 0 and 2.

19. The method of claim 17, wherein the multivalent metal ion is provided by a multivalent metal salts comprising a multivalent metal ion and a negative ion wherein the multivalent metal ion is selected from the group consisting of Ba, Ca, Ce, Co, Cu, La, Mg, Mn, Ni, Nb, Ag, Ti, Al, Zn, Pb, Fe, Hg, Cr, Cd, Sn, Pb, Sb, and Bi; and
wherein the negative ion is selected from the group consisting of hexafluorophosphate ion; tetrafluoroborate ion; chlorate ion; C(SO₂CF₃)₃⁻ ion; PF₄(CF₃)₂⁻ ion; PF₃(C₂F₅)₃⁻ ion; PF₃(CF₃)₃⁻ ion; PF₃(iso-C₃F₇)₃⁻ ion; PF₅(iso-C₃F₇)⁻ ion; bis(fluorosulfuryl) imide ion, bis(trifluoromethanesulfonyl) imide ion, bis(perfluoroethylsulfonyl) imide ion, linear imide ions having a general structure N(—SO₂—R)₂⁻, wherein at least one R is a fluorinated alkyl having a chain length of from 1 to 8, cyclic imide ions having a general structure N(—SO₂—R—)⁻, wherein R is fluorinated alkyl having a chain length of from 1 to 8; methide ion having a general structure C(—SO₂—R)₃⁻, wherein R is a fluorinated alkyl with a chain length of from 0 to 8; bisoxalatoborate; and difluorooxalatoborate.

20. The method of claim 17, wherein the solution is an electrolyte solution and a concentration of the multivalent metal salt in the solution is between 0.01M and 0.2M.

21. The method of claim 17, wherein the solution comprising the multivalent metal salt is an electrolyte of a lithium ion cell, the electrolyte further comprising a lithium containing salt, wherein the lithium containing salt is selected from the group consisting of LiPF₆, LiBF₄, LiClO₄ LiAsF₆, LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, and LiPF₅(iso-C₃F₇).
